(19) United States
(12) Patent Application Publication
(10) Pub. No.: US 2026/0179910 A1
(43) Pub. Date: Jun. 25, 2026

(54) CARBON-SILICON COMPOSITES AND METHOD OF PRODUCTION THEREOF

(71) Applicant: NANOVACE TECHNOLOGIES LIMITED, Kolkata (IN)

(72) Inventors: Jawad HAIDAR, Kogarah (AU); Mohammadreza ESKANDARIAN, Kogarah (AU); Jing LIANG, Kogarah (AU); Rajan GNANARAJAN, Kogarah (AU)

(21) Appl. No.: 19/124,896

(22) PCT Filed: Oct. 28, 2023
(86) PCT No.: PCT/AU2023/051094

§ 371 Date: Apr. 28, 2025

(30) Foreign Application Priority Data
Oct. 28, 2022 (AU) 2022903197
Jun. 23, 2023 (AU) 2023901993
Aug. 23, 2023 (AU) 2023902690

(51) Int. Cl. H01M 4/133; H01M 4/38; H01M 4/587

(52) U.S. Cl. CPC H01M 4/133; H01M 4/386; H01M 4/587

(57) ABSTRACT

Disclosed herein is a method for producing carbon-silicon composites. The method comprises providing a reaction mixture comprising a carbon-silica-based precursor and an aluminium reductant; heating the reaction mixture in the presence of solid or gaseous aluminium chloride, or a mixture thereof, to a temperature at which reactions that result in the silica being reduced are initiated; controlling reaction conditions whereby the reaction mixture is prevented from reaching a temperature at which thermal runaway can occur; and isolating the produced carbon-silicon composites.

### RELATED APPLICATION

The patent application is a National Stage Application of PCT/AU2023/051094, filed on Oct. 28, 2023, which claims priority from Australian patent application number 2022903197, filed on Oct. 28, 2022; 2023901993, filed on Jun. 23, 2023; and 2023902690, filed on Aug. 23, 2023 which is incorporated herein by reference for all purposes.

### TECHNICAL FIELD

The present invention relates to methods for the production of carbon-silicon composites and, in particular, methods for the production of carbon-silicon nanoparticles for use in batteries.

### BACKGROUND ART

There has been considerable recent interest in microporous (or nano-porous) silicon for applications relating to Li-ion energy storage systems. The use of silicon powder with appropriate superfine morphology as anode materials in Li-Ion batteries (LIBs) can provide considerable increase in battery capacity. However, using silicon as an anode material can result in excessive volume increases during lithiation of the silicon-based anode. To minimise the resulting impact on battery structure and integrity, a number of strategies centring on the use of carbon-silicon composites for use as anode materials have been proposed. In such strategies, silicon nanoparticles (Si—NP) are typically combined with carbon with the aim of improving or accommodating volume changes during the lithiation/de-lithiation cycle and providing increased electrical conduction. Typically, such carbon-silicon composites are prepared through pyrolysis, mixing and/or milling of carbon and Si—NP. Such approaches suffer from limitations, however, including higher expense incurred due to additional steps required to introduce the carbon, as well as an inability to control the structure of the carbon-silicon composites. There is also the problematic quality and/or the high cost of producing the Si—NP through conventional routes such as milling, magnesium reduction, laser ablation, etc. Therefore, there is need for a novel and more affordable approach to produce carbon-silicon composites capable of use in Li-Ion-batteries and other applications.

### SUMMARY OF INVENTION

In a first aspect, the present invention provides a method for producing carbon-silicon composites. The method comprises:
providing a reaction mixture comprising a carbon-silica-based precursor and an aluminium reductant;
heating the reaction mixture in the presence of solid or gaseous aluminium chloride, or a mixture thereof, to a temperature at which reactions that result in the silica being reduced are initiated;
controlling reaction conditions whereby the reaction mixture is prevented from reaching a temperature at which thermal runaway can occur; and
isolating the produced carbon-silicon composites.

The present invention provides improvements over the methods disclosed in international patent application no. PCT/AU2021/050400, in that it enables the production of carbon-silicon composites starting from a carbon-silica-based precursor. The methods disclosed in PCT/AU2021/050400 provide for the reduction of silica and metal oxides, but it was expected that the presence of carbon in the reaction mixture would prevent, or at least substantially hinder, the reduction reactions. The presence of carbon was expected to reduce contact surface area between the reducible silica and the reducing aluminium, hence impeding the reaction and making it difficult (if not impossible) to obtain any significant degree of reduction. The inventors have surprisingly and unexpectedly discovered, however, that this is not the case. The inventors have discovered that the advantageous effects of these methods can still be achieved, despite the presence of substantial amounts of (unreducible) carbon in the reaction mixture. The present invention can thus be used to produce carbon-silicon composites having nano-morphologies and structures compatible with use in Li-Ion batteries, but which is unobtainable using conventional aluminothermic reduction techniques (and indeed, other manufacturing techniques). The content of PCT/AU2021/050400 is incorporated herein in its entirely by reference.

The present invention provides a method for low-temperature production of carbon-silicon composites through direct in-situ production of silicon nanoparticles starting from silica-carbon based precursors. As will be described below, the by-products can include aluminium oxychloride, which is more easily separable than for conventional metallothermic reactions that usually lead to metal oxide byproducts. Hence, the present invention enables the direct production of pure carbon-silicon composites which are substantially free of metal oxides, and yields can be up to more than 99%.

Low-temperature aluminothermic reduction of silica (as well as other silicon oxides) is attractive as it enables reduction using solid aluminium reactants, with less energy consumption and with the potential to produce reaction products having nano-morphologies and structures usually unobtainable using normal aluminothermic reduction. Also, many aluminium reductants (e.g., Al powder) are safe, have a low-cost and are readily available, making the materials attractive from a techno-economic perspective.

Further, low temperature reduction of C—SiO₂ would allow for production of full carbon or graphite-silicon composites, silicon-impregnated carbon materials, C-silicon nanoparticles or microporous C-silicon starting from silica precursors with a morphology well suited for use in applications relating to Li-ion energy storage systems, such as those described above.

Therefore, at least in preferred embodiments, the invention may achieve a significant reduction in the complexity and steps required to produce C—Si composites; C—Si are produced at low temperatures directly, allowing for production of C—Si composite powders with improved engineered properties, as well as new products with unique characteristics imparted by the precursor materials and the production technique. Also, the approach disclosed here reduces production cost, in addition to providing mechanisms for controlling characteristics for the carbon-silicon products. The temperatures reached in conventional metallothermic reactions and the complexity of CVD systems, in addition to the steps required to combine carbon with silicon to produce composites preclude such advantages.

In some embodiments, the carbon-silica-based precursor may be provided in the form of one or more of: a carbon-silica composite, a mixture of carbon powder and a silica-based powder, a carbon-coated silica powder, carbon cages encasing silica-based precursor particulates, carbon nanotubes or thin graphitic sheets or graphene blended with silica particulates or coated onto the particulates, a reducible carbon-silicon-oxygen based powder, a porous carbon-based structure impregnated with silica, a silica-impregnated carbon-based powder, a silica-impregnated graphite powder, a silica-impregnated charcoal powder, pyrolyzed rice husks, a powder of natural graphite that contains silica, or a mixture thereof.

The inventors realised that the presence of silicon nanoparticles or sub-nanoparticles embedded within graphite used in LIBs can be advantageous as it increases the electrode capacity; silicon has the capacity to carry 10 times more power than carbon in LIBs. The inventors have discovered that it is possible to produce carbon-silicon composites such as silicon-impregnated graphite, and silicon nanoparticles or silicon nanostructures coated or encased in graphene/graphitic materials through direct reduction of carbon-silica precursor chemicals with appropriate structure and morphology.

Furthermore, natural graphite is a key ingredient for manufacturing anodes for lithium-ion-batteries (LIBs). The material is mined in a number of countries throughout the globe and then processed to remove impurities and increase carbon content to ˜99% before use as anode for LIBs. Purification can involve crushing and grinding, froth floatation, acid leaching using sulfuric or hydrochloric acids, and thermal treatment, and these processes are usually capable of increasing purity to around 95%. For some grades, increasing purity beyond 95% is demanding and may require use of highly aggressive chemicals such as HF in order to remove residual silicon oxide and magnesium oxide. HF is very hazardous, requiring extreme measures to contain OH&S aspects and potential environmental impact. Therefore, there is need for a novel affordable approach to produce eliminate residual impurities from the graphite material and/or convert the impurities into forms suitable for and/or compatible with use in Li-Ion-Batteries.

The inventors realised that for natural graphite, the end purified product can be made to be of higher value if the silica present in the material can be converted into silicon. As outlined elsewhere, silicon nanoparticles provide significant capacity enhancement when added to graphite in Li-batteries anode. Therefore, it would be highly advantageous to convert the silica impurities in natural graphite to silicon and use the resulting materials as anode materials rather than eliminating the silica through hazardous chemical processing. Moreover, while converting silica into silicon, it would be possible to reduce and/or eliminate other impurities present such as magnesium oxide, iron oxide and other metal-based impurities.

In some embodiments, the carbon-silica-based precursor may be provided in the form of a powder, flakes, fibres or particulates.

In some embodiments, the method may further comprise pyrolyzing a mixture of a silica-containing substance and a carbon-based compound to produce the carbon-silica-based precursor. The carbon-based compound may, for example, be selected from the group consisting of one or more of the following: an organic compound, a polymer, a carbohydrate, a saccharide, glucose, sucrose, a biomass and a hydrocarbon. The carbon-based compound may, in some embodiments, be applied to the silica-containing substance by physical deposition (e.g. physical vapour deposition), chemical deposition (e.g. chemical vapour deposition), wet processing, or any other means resulting in forming a powder containing silica with the carbon-based compound.

In some embodiments, the method may further comprise impregnating a carbon-based material with a liquid precursor comprising silicon and then treating the resulting material to produce a carbon-silica-based precursor in the form of a graphite-silica powder. The liquid precursor comprising silicon may, for example, be selected from one or more of: silicic acid, sodium silicate and silicon alkoxides. In some embodiments, the carbon-based material may be selected from one or more of: graphite, synthetic graphite, natural graphite, activated carbon, graphene, carbon nanotubes, graphite-minerals mixture, charcoal powder, pyrolyzed rice husks, carbonised materials produced from pyrolysis of organic materials, graphitic or carbonised materials produced by reacting organic materials with acids, and anode grade graphite powder.

In some embodiments, the silica in the carbon-silica-based precursor may be provided in the form of a powder, independent particulates, particulates impregned within the carbon structure, or in the form of other morphologies comprising silica.

In some embodiments, the silica in the carbon-silica-based precursor may be provided as one or more of: silica nanopowder, fumed silica, precipitated silica, silica fume, silica fibre, silicate, borosilicate, soda glass, silica-based minerals such as halloysite and kaolinite, synthetic mica, mica and crystalline silica.

In some embodiments, the silica in the carbon-silica-based precursor may have a particle size of less than 100 microns, preferably less than 10 microns, more preferably less than 5 microns, and still more preferably less than 500 nm. In some embodiments, the silica in the carbon-silica-based precursor may even have a particle size of less than 100 nm.

In some embodiments, the solid aluminium chloride may be provided in the form of a powder or granules of aluminium chloride with a particle size less than 5 mm. In some embodiments, the aluminium chloride may be included in the reaction mixture.

In some embodiments, the gaseous aluminium chloride may be caused to flow over or through the reaction mixture during heating.

In some embodiments, the amount of the aluminium chloride provided may be between about 1 wt % and about 500 wt % of the weight of the carbon-silica-based precursor. The amount of the aluminium chloride provided may, for example, be between about 10 wt % and about 300 wt %, between about 50 wt % and about 300 wt %, between about 100 wt % and about 200 wt %, between about 100 wt % and about 500 wt % or between about 100 wt % and about 150 wt % of the weight of the carbon-silica-based precursor.

In some embodiments, the aluminium reductant may be aluminium or an aluminium alloy.

In some embodiments, the aluminium reductant may be provided in the form of a powder or flakes with a particle size of less than about 50 μm (e.g. less than about 40 μm, less than about 30 μm or less than about 20 μm) in at least one dimension. In alternative embodiments, however, the particle size may be up to 100 microns or even up to 500 microns.

In some embodiments, the amount of the aluminium reductant in the reaction mixture may between 1% and 1000% of the weight of the silica in the carbon-silica-based precursor, and preferably between 5 wt % and 500 wt % of the weight of the silica in the carbon-silica-based precursor.

In some embodiments, the temperature to which the reaction mixture is heated may be less than 800° C., preferably less than 600° C. or preferably less than 550° C.

In some embodiments, the reaction mixture may be heated in a non-reactive atmosphere and preferably in an inert atmosphere (i.e., an atmosphere that is inert to the reactants, which may include a CO₂ or N₂ atmosphere).

In some embodiments, the reaction mixture may be heated at a pressure of between about 0.8 to 1.2 atmospheres, preferably at atmospheric pressure. Reactions performed at, or near, atmospheric pressure require less sophisticated equipment, are safer and are generally cheaper to perform.

In some embodiments, the reaction conditions may be controlled by one or more of the following: gradually feeding additional one or both of the carbon-silica-based precursor and the aluminium reductant into the reaction mixture as it is heated; by externally cooling the reaction mixture; by cooling the reaction mixture with excess amounts of solid aluminium chloride; and by adding a thermal load moderator to the reaction mixture. Gradual introduction of reactants to the reaction mixture (in particular the Al and AlCl3), for example, prevents thermal runaway due to the limited and controllable availability of reactants at any given time.

In some embodiments, alloying additives and metal-based catalysts may be included in the reaction mixture. For example, in some embodiments, compounds based on one or more of Li, B, Na, Mg, Al, S, K, Ca, Ti, V, Cr, Mn, Fe, Co, Ni, Cu, Zn, Ge, Se, Zr, Nb, Mo, Ru, Rh, Pg, Ag, Sn, Sb, Hf, Ta, W, Re, Os, Pt, Au and Bi may be included in the reaction mixture. In some of such embodiments, the metal-based catalyst or additive can act to induce formation of carbon-silicon composites in the form of carbon-silicon nanowires. For example, the use of metal based catalysts such as Ag, AgCl, Zn and ZnCl₂ results in the formation of carbon-silicon nanowires.

In some embodiments, the carbon-silicon composites may comprise silicon nanoparticles encased within carbon-based structures. In such embodiments, the method may further comprise processing the carbon-silica-based precursor to control the volume of empty space within the carbon-based structures. In some of such embodiments, the carbon-based structures may be carbon-based shells. In some of such embodiments, the core may comprise empty space of between 0.5% and 75% (e.g. between 0.5% and 50%) of the total volume of the core.

In some embodiments, performance of the method may result in carbon-silicon composites comprising between 0.01 wt % and 70 wt % residual aluminium. The inventors believe that composites including residual aluminium is a unique characteristic of the present invention, and one likely to impart useful functionality to the composite. For example, the presence of residual aluminium oxide can help improve performance of the materials as anodes for Li-ion-batteries. Also, as aluminium solubility in metallic silicon is negligible, the presence of residual metallic aluminium would not impede the ability of silicon to store lithium, while it may increase the conductivity of the anode.

In some embodiments, performance of the method may result in carbon-silicon composites including silicon-compounds having an average composition corresponding to SiOx, where x is between 0 and 1.9.

In a second aspect, the present invention provides a carbon-coated silicon nanoparticle produced according to the method of the first aspect, wherein the silicon nanoparticles are in the form of particulates having irregular shapes and a mean particle size of between 10 nm and 500 nm and include between 0.01 wt % and 70 wt % aluminium.

In a third aspect, the present invention provides a carbon-silicon composite produced according to the method of the first aspect, wherein the composite comprises particles having a silicon-containing core and a coating having a thickness of between 1 nm and 300 nm and containing at least 50 wt % silicon.

In a fourth aspect, the present invention provides a carbon-silicon composite produced according to the method of the first aspect, wherein the composite is in the form of a core-shell structure, wherein the core comprises empty space of between 0.5% and 75% (e.g. between 0.5% and 50%) of the total volume of the core and silicon-based materials with a metallic silicon content less than 99 wt %; and the shell comprises a porous or non-porous carbon coating having a thickness between 0.01 nm and 1 micron.

In a fifth aspect, the present invention provides a method for reducing silica in a silica-based precursor. The method comprises:
coating a silica-based powder with carbon to produce a carbon-coated silica-based precursor;
providing a reaction mixture comprising the carbon-coated silica-based precursor and an aluminium reductant;
heating the reaction mixture in the presence of solid or gaseous aluminium chloride, or a mixture thereof, to a temperature at which reactions that result in the silica being reduced are initiated;
controlling reaction conditions whereby the reaction mixture is prevented from reaching a temperature at which thermal runaway can occur; and
isolating reaction products that include reduced silica.

Specific embodiments of the method of the fifth aspect will be described below. In a first embodiment, the method comprises:
mixing a liquid soluble carbon-based compound with a solvent and a silica-based precursor; and
evaporating the solvent to produce a silica-based precursor coated with a carbon-based compound;
pyrolyzing the silica-based precursor coated with a carbon-based compound to produce a carbon-coated silica-based precursor;
heating a reaction mixture comprising the carbon-coated silica-based precursor and an aluminium reductant at substantially atmospheric pressure and in the presence of gaseous aluminium chloride to a temperature at which reactions that result in the SiO₂ being reduced are initiated;
controlling reaction conditions whereby the reaction mixture is prevented from exceeding a temperature of about 650° C.; and
isolating reaction products that include silicon.

In a second embodiment, the method comprises:
forming a reaction mixture of carbon, a silica-based powder, an aluminium reductant and a metal catalyst, wherein the weight of the catalyst is between 5% and 50% of the weight of the silica, and wherein the catalyst induces formation of silicon nanowires;
heating the reaction mixture at atmospheric pressure in the presence of gaseous aluminium chloride to a temperature at which reactions that result in the SiO₂ being reduced are initiated;
controlling reaction conditions whereby the reaction mixture is prevented from exceeding a temperature of about 650° C.; and
isolating reaction products that include carbon-silicon nanowires.

The second embodiment may further comprise impregnating a carbon-based material with a liquid precursor comprising silicon and then treating the resultant material to produce the silica-based powder in the form of a graphite-silica-based powder.

In a sixth aspect, the present invention provides a method for producing carbon-silicon composites. The method comprises:
providing a powder of natural graphite which contains between 0.1% and 20% per weight silica; and
mixing and heating the powder with a reducing agent comprising aluminium in the presence of solid and/or gaseous aluminium chloride, whereby at least a part of the silica is reduced to silicon and a carbon-silicon composite powder is produced, together with a byproduct comprising Al2O3 and/or AlOCl; and
optionally separating the carbon-silicon composites from the byproducts.

In a seventh aspect, the present invention provides carbon-silicon composites produced according to the method of any of the first, fifth and sixth aspects.

In an eighth aspect, the present invention provides silicon-impregnated carbon-based composites produced according to the method of any of the first, fifth and sixth aspects, wherein the carbon-based material in the carbon-silica-based precursor is graphite, pyrolyzed biomaterials or activated carbon.

In a ninth aspect, the present invention provides a natural graphite-silicon composite produced according to the method of the first or sixth aspect, wherein silica impurities in natural graphite are converted in part or in full to silicon to produce a compound of natural graphite-Si composite, wherein the silicon content is between 0.5 wt % and 25 wt %.

In a tenth aspect, the present invention provides a carbon-silicon composite produced according to the method of any of the first, fifth and sixth aspects, wherein silica in pyrolyzed carbon-silica precursor compounds is reduced to silicon; the silicon content is between 1 wt % and 25 wt %.

In an eleventh aspect, the present invention provides carbon-silicon composites consisting of carbon, silicon and aluminium.

In a twelfth aspect, the present invention provides carbon-silicon composites produced solely from rise husks or natural graphite.

In some embodiments of the eleventh and twelfth aspects, the carbon-silicon composite is produced using the methods of the present invention.

Also disclosed herein is a method for producing carbon-silicon composites. The method comprises:
providing a mixture of silica-based powder and carbon-based materials; the mixture can be in the form of a blended mixture of silica-based powder and a carbon-based powder, or a powder of carbon-coated silica precursors or a powder of silica-impregnated carbon-based materials, or a powder of natural graphite comprising silica-based impurities; and
reacting the said mixture with an aluminium-based reductant comprising an aluminium powder and aluminium chloride at temperatures between 300° C. and 650° C.; the aluminium chloride is in the form of a solid or gaseous form; and
the reacting step results in formation of a powder mixture of a reduced silica-carbon product and an aluminium-based by-product; the product contains carbon and silicon-compounds SiOₓ with x between 0 and 1.9; and
separating the reaction product;
the carbon-based materials can be in any form of phase, including graphite, synthetic graphite, natural graphite, activated carbon, graphene, carbon nanotubes, charcoal, graphite-minerals mixture, carbon-based minerals, graphitic materials produced from pyrolysis of organic materials, graphitic materials produced by reacting organic materials with acids, anode grade graphite powder, a powder of charcoal, a powder of pyrolysed rice husks, or synthetic graphite. The carbon-based materials can be in the form of flakes, spherical powders, porous graphite powder, graphene, carbon nanotubes, carbon nanostructures, and they can be coated or uncoated; and
the carbon-based materials can be in the form of a coating on the silica-based precursor particulates, carbon cages encasing the silica-based precursor particulates, thin graphitic sheets or graphene blended with the silica particulates or coated onto the particulates. Also, the carbon-based materials can be in the form of a porous structure impregnated with silica or silicon-oxygen based compounds. within the pores of the carbon-based materials, or simply in the form of a powder mixed with the silica-based precursor.

Also disclosed herein is a method for producing carbon-silicon composites. The method comprises:
providing a reactant powder comprising silica-based compounds and a carbon/graphite-based compounds; and
mixing, heating and reacting the reactant powder with an aluminium-based reductant comprising aluminium and aluminium chloride to reduce at least a part of the silica to silicon; and
separating the silicon-carbon products.

Also disclosed herein is a method for producing carbon-silicon composites. The method comprises:
providing a first reaction mixture comprising a silica-based powder mixed or coated with a carbon-based compound; and
processing the said reaction mixture to convert the carbon-based compound to a stable carbon-based material; and
mixing, heating and reacting the resulting mixture of carbon-based materials-silica-based powder with an aluminium-based reductant comprising aluminium and aluminium chloride to reduce at least a part of the silica to silicon; and
separating the silicon-carbon products.

In some embodiments, the silica-based powder is coated with a carbon-based compound.

In some embodiments, the coated powder is first processed to produce a stable carbon-based coating around the silica-based powder, before proceeding to reducing the silica to silicon. Examples of suitable means include coating with polymers or other organic compounds followed by appropriate carbonisation, or other coating techniques such as chemical vapour deposition and physical vapour deposition.

In some embodiments, the silica-based powder is coated with compounds based on organic materials that can be pyrolyzed to produce an intermediate product of carbon-coated silica-based powder. Examples of suitable organic compounds include sugar and glucose.

In some embodiments, the silica-based powder is coated with glucose that is then pyrolyzed to produce an intermediate product of carbon-coated silica-based powder.

In some embodiments, the silica-based powder is first coated using appropriate means with organic compounds such as carbohydrates or saccharides. The coated powder is then pyrolyzed to produce an intermediate product of carbon-coated silica-based powder.

In some embodiments, the carbon coating over the SiO₂-based precursor powder is not continuous.

In some embodiments, the carbon coating over the Si-based particle products is not continuous.

In some embodiments, the carbon coating over the SiO₂-based precursor powder is porous.

In some embodiments, the carbon coating over the Si-based particle products is porous.

In some embodiments, soluble silicon-based compounds are impregnated into a graphite powder, then processed to convert into silica, resulting in an intermediate precursor in the form of a silica-impregnated graphite powder. The intermediate precursor is then reacted with aluminium-aluminium chloride to produce an intermediate product in the form of silicon-impregnated graphite powder and aluminium-based by-product. The intermediate product is then processed to remove the by-product.

In one example of this embodiment, the soluble silicon-based compound is sodium silicate. The sodium silicate is first dissolved in water and then mixed with a graphite powder that is preferably porous. An acidic reagent such as HCl in then added to convert the silicate into aluminium hydroxide. The resulting mixture is then calcined to convert the hydroxide to an oxide and the resulting powder is thoroughly washed the remove the NaCl resulting from the neutralisation process. The remaining intermediate precursor powder consists of a graphite powder with silica particles deposited on all available surfaces including the pores and external surfaces of the graphite powder. The intermediate precursor is then reacted with aluminium-aluminium chloride to produce an intermediate product in the form of silicon-impregnated graphite powder and aluminium-based by-product. The intermediate product is then processed to remove the by-product.

In other embodiments, the intermediate precursor powder of silica impregnated porous carbon can be produced by first impregnated an organic material with silica and then pyrolyze/carbonise to produce a graphitic powder impregnated with silica.

In some embodiments, the aluminium chloride may be provided in the form of solid aluminium chloride. The aluminium chloride may be provided in the form of a powder or granules with a particle size less than 5 mm. In some embodiments, the aluminium chloride powder may be included in the reaction mixture (e.g., pre-mixed with the aluminium reductant). Here, the AlCl₃(s) sublimes helping remove energy away from the reactants and counterweight the effects of exothermic energy generated by reactions of Al—AlCl₃ with SiO₂.

In some embodiments, the aluminium chloride may be provided in the form of gaseous aluminium chloride. The gaseous aluminium chloride may, for example, be caused to flow over the heated reaction mixture.

In some embodiments, the temperature to which the reaction mixture is heated (i.e. in order to initiate the reduction reactions) may be less than 800° C., preferably less than 600° C. or preferably between 200° C. and 600°. As described herein, lower temperatures of reaction are preferable because the reaction products are not molten (and hence more easily purified) and may retain the morphologies of the reagents.

In some embodiments, the product is further reacted with reagents to reduce the volume of Si encased with the carbon shells. Examples of suitable reagents includes acids.

In some embodiments, the intermediate carbon-silica precursor is reacted with reagents to reduce the amount of Si encased with the carbon shells or pores and create voids with the shells or pores to allow for formation of the aluminium oxychloride by-products and then to allow space for the end product of carbon-encased silicon to expand during lithiation of the silicon.

In some embodiments, the silica-based precursor may include metal additives and then the product may include elemental metal, a metal suboxide, an alloy including the metal, a compound including the metal, a composite including the metal or mixtures thereof.

In some embodiments, the reaction products may comprise the product resulting from reducing the precursor and one or more by-products of aluminium chloride, aluminium oxychloride, and aluminium oxide. In some embodiments, the reaction products may be further processed to separate by-products from the product resulting from reducing the precursor. In some embodiments, the by-products may include aluminium oxychloride, where the aluminium oxychloride is separable from the reduced metal oxide by washing the reaction products in an aqueous medium.

In some embodiments, any gaseous aluminium chloride not consumed by during the reaction may be condensed for beneficial reuse, such as for recycling back into the reaction mixture.

In some embodiments, heating the reaction mixture comprises a plurality of heating steps and the formation of intermediate species. Embodiments of such will be described in further detail below.

In one embodiment of the method of the first aspect of the present invention, the silica-based precursor is SiO₂ and the SiO₂ is first processed to produce a C—SiO₂ precursor powder, the aluminium reductant is aluminium or an aluminium alloy in a solid powder form, the reaction mixture is heated to an initiation temperature of between about 200° C. and 600° C. (preferably between 300° C. and 550° C.) and the reaction conditions controlled to maintain the temperature below about 650° C. The reaction products of such a method may be a composite of carbon and silicon or a mixture of silicon and SiO₂ having a particle size of less than 500 nm. In some embodiment the particles can be in the form of agglomerates with a size up to more than 10 microns. In some other embodiments, the reaction products can include a mixture of silicon and Al₂O₃.

Also disclosed herein is a carbon-coated silicon powder produced according to the method described in the preceding paragraphs, wherein the silicon powder is in the form of particulates with irregular shapes and a mean particle size between 1 nm and 500 nm; and the composition includes Al at levels between 0.01 wt % and 70 wt %.

Also disclosed herein is a carbon-silicon composite powder, with particulates consisting of a carbon cage with a cavity comprising silicon-based particles and void space, wherein the volume ratio of void to the silicon based materials can be between 1% and 80%. The carbon cage consists of graphitic carbon materials made of graphite, graphene or related compositions and it can be porous. The thickness of the cage wall can be between 0.01 nm and 10 microns, and preferably between 0.1 nm and 100 nm and more preferably between 0.1 nm and 10 nm. The particle size of the C—Si particulates produced according to this aspect can be between 1 nm and 50 microns. For this aspect, the method includes the steps of producing carbon-coated silica precursors, and then etching parts of the coated silica and reacting the resulting materials according to any of the embodiments.

Also disclosed herein is a method for reducing SiO₂ in a SiO₂ containing precursor. The method comprises:
providing a reaction mixture comprising the carbon-coated precursors containing SiO₂ and an aluminium reductant; and
heating the reaction mixture at atmospheric pressure in the presence of gaseous aluminium chloride to a temperature at which reactions that result in the SiO₂ being reduced are initiated; and
controlling reaction conditions whereby the reaction mixture is prevented from exceeding a temperature of about 650° C.; and
isolating reaction products that include silicon.

Also disclosed herein is a carbon-silicon composite powder, consisting of a mixture of graphene or graphitic powder and silicon nanoparticles, wherein the powder is produced by reducing a carbon-coated silica powder with Al—AlCl₃.

Also disclosed herein is a method for producing a carbon-silicon composites, wherein a mixture of silica and a carbon-based precursor is first reduced with acid to produce a silica-carbon mixture and then then the mixture is reduced to Si—C using Al—AlCl₃.

Also disclosed herein is a product in the form of graphite powder impregnated with silicon. The silicon can be in the form of nanoparticles or nanowires.

In one embodiment for production of graphite powder impregnated with silicon nanowires, the method comprises the primary step of depositing a metal-based catalysts within the pores of the graphite particles, and then adding silica-based precursors and processing the resulting materials according to any of the foregoing or forthcoming embodiments or aspects.

Given the similarities between aluminothermic and magnesiothermic processes, the inventors believe that the teachings of the present invention will also be applicable to a reductant using magnesium-aluminium chloride, where a magnesium reductant is used in place of an aluminium reductant.

### BRIEF DESCRIPTION OF DRAWINGS

Features, embodiments and advantages of the present invention will become apparent from the following description of embodiments thereof, by way of example only, with reference to the accompanying drawings, in which:

FIG. 1 shows a process schematic for one example embodiment illustrating steps for reducing a C—SiO₂ based precursor with Al in the presence of gaseous AlCl₃.

FIG. 2 shows TEM micrograph of C—Si powder obtained using PVP coating.

FIG. 3 shows an XRD trace for C-coated Si powder in example 10.

FIG. 3 shows an XRD trace for a pure Si sample obtained without the carbon coating in example 10.

### DETAILED DESCRIPTION

Herein, and unless explicitly expressed otherwise:
the terms “aluminium reductant”, “reducing Al agent”, “reducing Al alloy” and “reducing Al powder” are used interchangeably and refer to powders of pure Al and alloys based on Al,
references to a material being “based on”, for example the base metal or alloy based on Al as a reducing agent, refer to the material comprising at least 10% and preferably at least 50% of the nominated constituent,
the term “aluminium chloride” refers to the chlorides of Al such as AlCl₃ and Al₂Cl₆. Where used, the terms “aluminium chloride” or “aluminium chlorides” or “AlCl₃” include reference to any anhydrous metal chlorides based on Al—Cl, in both gaseous form and solid form,
where used, the term “AlCl₃(g)” refers to any aluminium chlorides in a gaseous or vapour form,
where used, the term “AlCl₃(s)” refers to any aluminium chlorides in a solid powder form,
the terms “AlOCl/Al₂O₃” means AlOCl and/or Al₂O₃,
the terms “AlOCl” and “aluminium oxychloride are used interchangeably, and
the terms “silicon oxide”, “silica” and “SiO₂” refer to silicon oxides in both amorphous and crystalline form.
the terms “C-based coating”, “carbon-based coating” are used to describe coating compounds based on carbon. “C-coated” and “carbon-coating” are used to describe coating based on pure carbon or on stable carbon-compounds.

Disclosed herein is a method for forming carbon-coated silicon-based powders or carbon-encased silicon-based powders through reacting a powder mixture comprising carbon-coated reducible precursor SiO₂-based precursor and a reducing Al alloy (e.g., Al powder) in the presence of aluminium chlorides to reduce the silica partially or entirely to silicon. The aluminium chlorides are in the form of a solid powder form or a gas/vapour form. In some embodiments, the aluminium chloride can be in the form a liquid eutectic phase.

The reduction reaction between silica in the precursor and the reducing reactants of Al and AlCl₃ are exothermic, and the method includes procedures for controlling the reduction reaction and moderating the reaction rate in order to prevent thermal runaway and the attendant reaction products.

The product of the method is a powder based on carbon and Si, and the by-products may comprise aluminium chloride and aluminium oxychloride and/or aluminium oxide. The aluminium oxychloride/aluminium oxide by-products are discharged with the product and can be constituents of the powder product or they can be separated by appropriate means. The aluminium oxychloride by-products can be separated from the base metals (e.g. Si powder) by washing in a suitable solvent (e.g., H₂O or diluted HCl(H₂O—HCl)).

Example forms of the inventive method aim to achieve significant reduction in the complexity and the number of steps, and also the temperature required by conventional reduction techniques and other existing processes requiring high temperatures or high pressures. This is in addition to providing means for controlling the volume of empty space within the carbon encasing of the Si particulates. The examples form of the inventive method aim to provide powders of metal compounds with improved engineered properties and new products with unique characteristics inherited from the starting precursor oxides.

The present invention comprises a number of aspects, specific forms and embodiments of which will be described below.

In accordance with a first example, there is provided a method for direct production of silicon-carbon composites through reducing a carbon-silica based precursor chemicals with reducing agents based on Al in a solid form and aluminium chloride in a solid form or a gas/vapour form, preferably at atmospheric pressure, at temperatures below 800° C., and preferably below 600° C., and more preferably at temperatures between 100° C. and 600° C. and still more preferably at temperatures between 200° C. and 600° C., and still more preferably at temperatures between 200° C. and 600° C., and yet still more preferably at temperatures between 200° C. and 550° C., wherein the method includes:
creating a C—SiO₂ by any available means, including blending powders based on C-based and silica, impregnating a carbon-based powder with silica, coating SiO₂-based powder with organic coating and then convert to carbon, or creating porous graphitic structures impregnated with silica; and
mixing, heating and reacting a reactant mixture comprising powders based on C—SiO₂ and Al in the presence of solid or gaseous aluminium chloride; and
the product of the method comprises compounds based on the base metals; and the by-products include AlOCl and/or Al₂O₃; and wherein
the products of the method are optionally processed to remove the by-products.

Examples of products include Si-impregnated graphite powder, C-coated metallic silicon nano-particulates, C—Si—Ag nanoparticles, carbon-coated SiO₂ particulates coated with metallic silicon, carbon-coated compositions corresponding to silicon monoxide (SiO or SiOₓ) or a mixture thereof. Other examples include C-shells encasing Si-nanoparticles and C-shells encasing porous Si particulates.

In accordance with a second example, there is provided a method for direct production of silicon-based particulates encased within carbon/graphitic structures, coatings or shells through reducing carbon-coated solid precursor chemicals based on base SiO₂ with reducing agents based on Al in a solid form and aluminium chloride in a solid form or a gas/vapour form, preferably at atmospheric pressure, at temperatures below 800° C., and preferably below 600° C., and more preferably at temperatures between 100° C. and 600° C. and still more preferably at temperatures between 200° C. and 600° C., and still more preferably at temperatures between 200° C. and 600° C., and yet still more preferably at temperatures between 200° C. and 550° C., wherein the method includes:
coating a SiO₂-based powder with a carbon-based compound and processing to produce a carbon/graphitic coating on the SiO₂-based particles, C—SiO₂; and
optionally removing, etching or dissolving parts of the coated/encased silica particles; and
mixing, heating and reacting the resulting C—SiO₂ powder with Al in the presence of solid or gaseous aluminium chloride; and
the product of the method comprises compounds based on the base metals; and the by-products include AlOCl and/or Al₂O₃; and wherein
the products of the method are optionally processed to remove the by-products.

Examples of products include C-coated metallic silicon nano-particulates, C—Si—Ag nanoparticles, carbon-coated SiO₂ particulates coated with metallic silicon, carbon-coated compositions corresponding to silicon monoxide (SiO or SiOₓ) or a mixture thereof. Other examples include C-shells encasing Si-nanoparticles and C-shells encasing porous Si particulates.

Gaseous aluminium chloride by-products may be continuously removed and solid by-products such as aluminium oxide and/or aluminium oxychloride may be discharged with the products and may be subsequently separated by appropriate post processing means.

In accordance with a third example, there is provided a method for production of metallic systems based on C—Si, wherein precursors comprising C—SiO₂ and a metal additive are reacted with an Al powder in the presence of gaseous aluminium chlorides AlCl₃(g) at temperatures between 200° C. and 800° C., and preferably at temperatures between 200° C. and 800° C., and more preferably at temperatures between 200° C. and 600° C. to produce a product comprising metallic alloys and compounds of the base metals and a by-product comprising aluminium oxychloride and/or aluminium oxide.

In accordance with a fourth example, there is provided a method for producing carbon-encased silicon nanoparticles, wherein precursors comprising C-coated SiO₂ powders are reacted with Al and gaseous aluminium chlorides:
at a pressure below 1.2 bar, and preferably at atmospheric pressure;
and at temperatures below 600° C., and preferably at temperatures between 200° C. and 600° C.;
to form a product comprising carbon-encased silicon nanoparticles and solid by-products comprising aluminium oxychloride (AlOCl). The silicon nanoparticles can be crystalline, amorphous or a mixture thereof. Alloying additives may be included through suitable additions to the silica-based precursor. Excess aluminium chloride is recycled through the process and other solid by-products are discharged with the powder products and can be subsequently separated from the silicon powder by appropriate post processing means; AlOCl and any residual Al may be removed by washing in a suitable solvent capable of dissolving AlOCl such as H₂O and diluted HCl(H₂O—HCl). Residual unreacted precursors can form a part of the final product or alternatively they may be removed using other suitable means. The C-encased silicon nanoparticles can be in various forms, including a porous skeletal form, a nanostructure particulate form, hollow spheres, nanoparticles, nanorods or nanowires.

In accordance with a fifth example, there is provided a method for producing carbon-silicon nanowires composites, wherein precursors comprising C—SiO₂ powders mixed with a metal catalyst precursor are reacted with Al and gaseous aluminium chlorides:
at a pressure below 1.2 bar, and preferably at atmospheric pressure;
and at temperatures below 600° C., and preferably at temperatures between 200° C. and 600° C.;
to form a product comprising carbon-silicon nanowires and solid by-products comprising aluminium oxychloride (AlOCl). The silicon nanoparticles can be crystalline, amorphous or a mixture thereof. Catalyst precursors may be included through suitable additions to the silica-based precursor of pure metallic powders, metal chlorides, metal oxides or a mixture thereof Suitable catalysts include powders based on the transition metals, including Ag, Cu, Zn, Au and Al. Excess aluminium chloride is recycled through the process and other solid by-products are discharged with the powder products and can be subsequently separated from the silicon powder by appropriate post processing means; AlOCl and any residual Al may be removed by washing in a suitable solvent capable of dissolving AlOCl such as H₂O and diluted HCl(H₂O—HCl). Residual unreacted precursors can form a part of the final product or alternatively they may be removed using other suitable means. The C-silicon nanowires can include other forms of Si, including a porous skeletal form, a nanostructure particulate form, hollow spheres, nanoparticles or nanorods.

It is known that silica can react with molten Al at temperatures between 700° C. and 1200° C., usually with a self-propagating reaction/thermal runaway, and leading to formation of molten mixtures including Al₂O₃, where removal of the Al₂O₃ is difficult. For the present disclosure, AlCl₃ in a solid form or a gaseous form is added to a mixture of SiO₂—Al and reacted at atmospheric pressure to reduce the threshold reaction temperature to below 600° C. and provide control over reaction mechanisms, which can advantageously lead to the formation of a specific products including reduced silica.

Moreover, the by-product is a solid AlOCl powder that can be separated from the reaction product by washing and filtering (e.g., in H₂O or diluted HCl)—in contrast to an Al₂O₃ by-product that is difficult to remove. Also, because reactions according to the present method do not involve liquid metals and no excessive heating, it is possible for a number of base metals to conserve morphological features from the starting SiO₂ precursor (e.g., Si nanopowders from SiO₂ nanopowders). Overall, the outcome includes significant improvements to the quality of the products with major simplifications in the processing conditions usually required.

It is known that SiO₂ can react with Al in molten AlCl₃ under high pressure conditions suitable for formation of liquid AlCl₃ and at temperatures up to 250° C. to produce a mixture of Si—SiO₂. This method, however, suffers from a number of significant problems, including the requirement for high pressure in order to produce molten AlCl₃. Further, despite long reaction times (>10 hours), the maximum reported yield is 75%. The inventors have discovered, that using gaseous AlCl₃ allows for reduction of SiO₂ to Si to be carried out at atmospheric pressure at temperatures between 200° C. and 600° C., with yields up to 99% over short times. Liquid AlCl₃ simply cannot exist under the reaction conditions of the present invention.

Example forms of the method provide an enhanced product technique with advantages over prior technologies, due to its ability to reduce processing temperatures and time, and extend the range of materials that can be produced. The exemplary forms of the present approach differ from prior art carbothermic and metallothermic processes in several other major aspects:
1—the novel method allows for the direct production of Si-impregnated carbon-based materials, natural graphite-silicon composites, rice husk-based derived carbon-silicon composites, or C-coated or C-encased Si particles; and
2—the method reduces the threshold reaction temperature and allows for synthesis of compositions and morphologies usually unobtainable under conditions prevailing in carbothermic and metallothermic processes (e.g., nanoparticle morphology, complex compositions); and
3—the method is carried out under relatively mild conditions of atmospheric pressure and relatively low temperatures; and
4—the process requires low energy input and produces no or minimal waste; and
5—Al is an attractive reducing agent due to its ready availability and low cost, and its compounds are valuable industrial chemicals and do not present considerable handling difficulties (e.g., AlCl₃); and
6—The process allows control over empty space within the encased shells.

### DETAILED DESCRIPTION OF THE INVENTION

As described above, in its preferred embodiments, the present invention provides a low temperature method for direct production of metallic compositions based on C—Si.

Disclosed herein is a method for reducing a solid precursor including silicon and carbon with a reducing Al alloy in a powder form and aluminium chloride in a reaction vessel at temperatures below 800° C., and preferably below 600° C., and more preferably at temperatures between 180° C. and 600° C., and still more preferably between 400° C. and 600° C., and most preferably between 200° C. and 600° C., wherein the method includes:
Step 1: creating a carbon-SiO₂ powder; this step can be through any means capable of producing such compositions, including:
   impregnating a graphite powder with silica; or
   creating a graphitic powder-silica composite; or
   coating an SiO₂-based precursor with a C-based compound and processing to carbonise the coating and produce a carbon coating on the SiO₂ based particles, C—SiO₂;
   and
Step 2: mixing, heating and reacting a reactant mixture comprising powders based on C—SiO2, with a reducing Al alloy in the presence of aluminium chloride;
   wherein the aluminium chloride is in a gaseous or solid form; and the amount is between 1% and 500 wt % of the weight of the precursor silica; and the product of the method comprises compounds based on silicon; and the by-products include aluminium chloride, and aluminium oxychloride and/or aluminium oxide; and
   wherein reactions between the silica and the reducing Al agent are exothermic; and
   wherein pressure in the reaction vessel is kept below the threshold pressure required to produce molten AlCl₃; and
   wherein one or more of the solid precursor powders based on C—SiO2, the reducing Al alloy powder and the aluminium chloride are gradually fed into the reaction vessel; and
Step 3: products at the end of Step 2 are processed to remove the by-products and obtain an end-product in the form of a powder based on C—Si.
Step 4: optionally reacting the powder with a reagent to remove a part of the Si-based particles encased within the carbon casing.

In contrast to existing techniques for reduction of silicon oxides, the present method enables reactions between SiO₂, Al and AlCl₃ to occur at about atmospheric pressure in the range 200-600° C. according to the overall reaction:

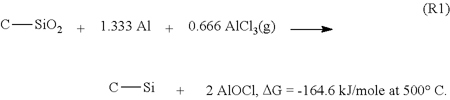

As outlined herein, the products can be in various forms including silicon-impregnated carbon, graphite-silicon composites, carbon coated silicon particles and carbon shell-silicon core shells. For all products, the present invention provides several advantages. For example, for the case of core-shell structure, there can be significant voids within the carbon shell to allow for expansion of the silicon during lithiation; starting volume of 1 mole of SiO₂ is 23 ml, and volume of resulting Si is 12 ml. Assuming all carbon-encasing shells remain intact, empty space within the C-shells would be around 47.8%, and this space can be used as a buffer for Si expansion during the lithiation process. Moreover, parts of the encased SiO2 particles may be removed before reduction to create more empty space within the encasing carbon shell and avoid breaking of the shell during reaction due to formation of Si and AlOCl, as per reaction R1.

The amount of empty space within the C-shells can be further increased through controlled etching of Si within the C-shells. Procedures for increasing volumes of empty space include reacting the C—Si composites with liquid chemicals capable of reacting with Si. The resulting Si compounds is dissolved and separated from the C—Si products. Examples include using strong acid such as concentrated acids and other appropriate chemicals capable of controllable reactions with Si.

Processing according to this scheme is carried out under inert gas (e.g., Ar, N₂ or CO₂) at 1 atmosphere in an open reactor vessel. Extensive testing has been carried out by the inventors to identify potential reaction mechanisms within the SiO₂—Al—AlCl₃(g) system. The results indicate that for fine precursor chemicals such as fumed silica and fine Al powder, yields up to 99% can be obtained for short processing times less than 1 hour.

The method of the present invention requires AlCl₃ to be in the gas phase with no formation of a molten AlCl₃ phase. Without wishing to be bound by theory, the high yield observed in the inventors' testing appears to be due to gas-solid reactions involving gaseous AlCl₃ and gaseous Al—Cl species. The presence of a liquid AlCl₃ phase can reduce the efficiency of the reactions as it becomes limited by the ability of molten AlCl₃ to diffuse through solid particulates to reach unreacted SiO₂ particulates and/or particulate core. Attempts to use liquid eutectic AlCl₃—NaCl as a source of AlCl₃ for reduction of SiO₂ resulted in much lower yields than observed with gaseous AlCl₃.

For all aspects and embodiments of the method, the AlCl₃ in the reaction vessel or reacting with the other reactants SiO₂—Al must not be in a molten state resulting from pressure increases, wherein the vessel is closed and heated in order to induce melting of the AlCl₃. For all aspects and embodiments, it is preferable that reactions in the SiO₂—Al—AlCl₃ according to the present disclosure are carried out in a vessel open to atmospheric pressure with no ability to build up pressure in the vessel.

### Precursor Chemicals and Products

As stated before, key effects and advantages of the present invention arise because of the AlCl₃ reacting with the carbon-SiO₂ reactants and aluminium at temperatures below the melting point of aluminium, leading to direct production of carbon-silicon composites such as C-encased Si nanoparticles. Discussion throughout this disclosure referring to reactions and mechanisms facilitating the role of AlCl₃ is only intended for highlighting various physical mechanisms involved and outlining aspects of the technology. This discussion is not intended to be comprehensive and/or to limit the present invention to any theory or mechanism of action.

Suitable precursors include amorphous SiO₂ powder, quartz powder, silica nanopowder, porous silica powder, precipitated, fumed silica, glass powder, glass flakes, borosilicate glass, natural mica, silica fume, silica minerals, halloysite, kaolinite, synthetic mica, silica impregnated carbon, silica impregnated graphite, charcoal impregnated with silica, natural graphite containing silica, pyrolyzed rice husks or any other composition based on SiO₂.

Suitable precursors for the carbon component of the precursor chemicals include graphite powder, activated carbon, biomass, charcoal, carbon containing organic compounds, polymers, and carbohydrates. Examples of preferred precursors include graphite powder, porous graphite powders, polyvinylpyrrolidone (PVP) and saccharides such as sucrose and glucose-based compounds.

The particle size of the precursors can be between a few nanometres and several millimetres, depending on characteristics of required end-products. However, small particle sizes less than 50 microns are preferred. Nanopowders with particle sizes less than 1 micron, and less than 100 nm, can be used, and usually, they lead to more effective reactions and better end-products. For example, silica nanopowders or fumed silica are preferred starting precursors to obtain silicon nanoparticles.

For Si, the inventors find that amorphous silica is better suited for the present reaction scheme as it is more reactive and can be obtained in finer forms than quartz. Thus, the Si in the starting SiO₂ precursors is preferably amorphous or porous with a large surface area.

The amount of SiO₂ reduced during processing can be between 0.1% and 100% of their starting weight. Remaining unreacted oxides and reducing agent are discharged as a part of products and may be separated in a post processing step if required.

The amount of the aluminium reductant (e.g. a reducing Al alloy) used depends on the starting precursor materials and the required composition of the end products and can be lower or higher than the stoichiometric amount needed to reduce all the reducible starting precursor chemicals. In some embodiments, the amount of the aluminium reductant in the reaction mixture may be between 1 wt % and 1000 wt %, between 5 wt % and 500 wt % and more preferably between 10 wt % and 200 wt %, and still more preferably between 50 wt % and 200 wt % of the weight of the silica in the carbon-silica-based precursor.

Preferably, the Al is in the form of a powder or flakes with a particle size less than 50 microns in at least one dimension. More preferably, the Al has a particle size between 1 micron and 50 microns in at least one dimension.

The amount of AlCl₃ used may, in some embodiments, be between 1 wt % and 500 wt %, preferably, between 1 wt % and 200 wt % and more preferably between 10 wt % and 200 wt %, and still more preferably between 50 wt % and 200 wt % of the weight of the carbon-silica-based precursor.

The weight ratio of silica, the reducing Al alloy and the AlCl₃ may be determined by a combination of factors, including the required composition of the end products and the stoichiometric requirements of reactions within the Si—O—Al—Cl systems.

For embodiments using solid aluminium chlorides, the starting solid AlCl₃ is preferably in the form of a powder or granules with a particle size less than 5 mm. More preferably, the starting solid AlCl₃(s) is in the form of a powder with a particle size less than 200 microns and more preferably less than 100 microns.

Processing is typically carried out under a protective gas, preferably at atmosphere pressure, in an open reaction vessel. Excess amounts of aluminium chloride may be used and AlCl₃(g) escaping or diffusing out of the reaction vessel may be condensed and returned to the reaction vessel during processing or collected in a dedicated vessel for later use or recycling. For processing according to R1, excess gaseous aluminium escaping the reaction vessel may be condensed and returned to processing in the initial phase of reaction R1, and then condensed and collected in a dedicated vessel for later use in the final phase of the reaction.

Excess amounts of aluminium chloride in a solid form may be fed together with other reactants into the reaction zone, and then at least a part of the excess AlCl₃ may sublime and help cool down the reactants. Sublimation heat of the AlCl3(s) in addition to the latent heat taken to heat up the AlCl₃ to the reactant temperature provides an effective means for cooling the reactants and controlling the reaction temperature.

Excess solid AlCl(s) may be fed with the other reactants and used to control the temperature of the reactants through absorbing heat due to sublimation. The resulting heated AlCl3 vapour is collected away from the reaction zone, cooled down and then fed back into the vessel directly or collected and recycled. The amount of AlCl3(s) fed into the reactor is controlled to maintain stable thermal processing conditions.

The method can be operated in a batch mode, a semi-continuous mode or in a full continuous mode, and AlCl₃ may be fed into the reaction zone/vessel as a solid powder that can either react with other precursors at low temperatures or sublimes into gaseous AlCl₃(g) during processing. Alternatively, AlCl₃ may also be fed into the reaction zone/vessel alone or preferably as an additional gas stream through the reactants (e.g., fluidised bed, packed bed, moving bed, rotary kiln or a stream of reactants continuously moved in a tubular reactor in a gaseous AlCl3 atmosphere) or in the reactant atmosphere.

Any residuals including aluminium chloride or oxychlorides, Al₂O₃, unreacted oxides and sub-oxides, other residual chlorides and also unreacted Al, can be removed from the product in post processing steps using appropriate means, including washing, chemical dissolution and vacuum sublimation.

For example, AlOCl can be removed by washing in diluted HCl. If Al₂O₃ formed and was present in the products, they may remain part of the end-product either as an independent component such as in composites or as part of a compound/particulates where the aluminium oxide reacts physically or chemically with species resulting from the reduction reaction.

Processing temperatures are typically above 200° C. and usually the products are substantially free of aluminium chloride, and any aluminium chloride residuals would be due to contamination during discharge and/or handling. Preferably, products of the method contain residual solid AlCl₃(s) impurities less than 5 wt % and preferably less than 1 wt %.

A person ordinarily skilled in the art of the invention would appreciate that the end-product may contain Al in the form of residual Al impurities or metal aluminides at levels between 0.01% and 70 weight (wt) %, and if needed, Al may be removed partially or entirely by various means including washing in chemicals such as diluted NaOH or diluted HCl.

In embodiments wherein precursor materials include reactive additives (e.g. alloying additives), the end products can include compounds containing the reactive additive(s). For example, for additives of carbon, boron, oxygen and nitrogen, respectively the products can comprise carbides, borides, oxides and nitrides.

### PREFERRED EMBODIMENTS

As discussed, reactions in the C—SiO₂—Al—AlCl₃ can result in significant exothermic energy release with the ability to raise the reactant temperature to more than 1500° C., and then hamper the quality of the products; for example, increasing reactant temperature above 700° C. can trigger uncontrollable direct reactions between SiO₂ and Al leading to formation of non-uniform compositions comprising Al₂O₃. The present invention advantageously overcomes these problems of the art and includes procedures for controlling exothermic heat generation and maintain the temperature at levels suitable for production of materials with uniform and acceptable characteristics. Reaction rates within the SiO₂—Al—AlCl₃(g) system are controlled though a combination of mechanisms including controlled feed rate for the reactants, mixing with pre-processed products and external heat management.

It is preferable that the method is carried out with gradual feeding of at least the Al and/or the AlCl₃, so that exothermic energy release is moderated, allowing for efficient thermal management of the reactants; for all example aspects and forms and embodiments, the method includes means for managing exothermic heat generation and maintaining the reactant and reactor temperature at a safe level.

In a preferred embodiment, the method includes:
preparing a powder comprising a carbon-based precursor and a SiO₂ based precursor, or a powder comprising a C—SiO₂ based precursor; and
processing the prepared powder as needed to carbonise the carbon-based precursor and produce a stable powder based of carbon-C—SiO₂; and
optionally loading all or part of the C—SiO₂ powder and gradually feeding remaining reactants including a reducing Al alloy and AlCl3(s) and/or AlCl3 (g) into a reaction vessel set at a temperature T₁ above a certain threshold reaction temperature below 800° C. and preferably below 650° C.; and
mixing and reacting the reactants in the presence of aluminium chlorides leading to a product based on C—Si, mixed with a by-product of AlOCl or Al₂O₃; and
wherein T₁ is below 600° C., and preferably between 180° C. and 600° C., and more preferably at between 160° C. and 600° C., and still more preferably at temperatures between 200° C. and 600° C., and still more preferably at temperatures between 200° C. and 600° C.; and
wherein the vessel contains amounts of processed reactants; and
wherein AlCl₃ is in solid form or a gaseous form; and where aluminium chloride is provided as a solid it may be provided together with the solid Al powder as a pre-mixed mixture; and
optionally separating the by-product and produce an end-product based on the base metals.

In one preferred embodiment, a stream of precursor C—SiO₂ powder and a stream consisting of a mixture of Al—AlCl₃ powder are gradually fed into a reaction vessel pre-heated at temperatures between 200° C. and 600° C. and preferably between 200° C. and 600° C. Processing is carried out under a non-reactive protective gas in a vessel at atmospheric pressure. For this embodiment, the reaction product is a mixture of Si powder and AlOCl. The product mixture is washed in diluted HCl to sperate the metallic Si powder. In one form of this embodiment, the precursor SiO₂ powder is a silica nanopowder and the product is a nanopowder of Si. In one other form, the precursor SiO₂ powder is a powder of fumed silica and the product is a nanopowder of Si. In other forms, the precursor SiO₂ powder is fumed silica. In one preferred form of this embodiment, the precursor C—SiO₂ powder is preloaded into the reaction vessel and a mixture of Al—AlCl₃ powder is then gradually fed into the reaction vessel.

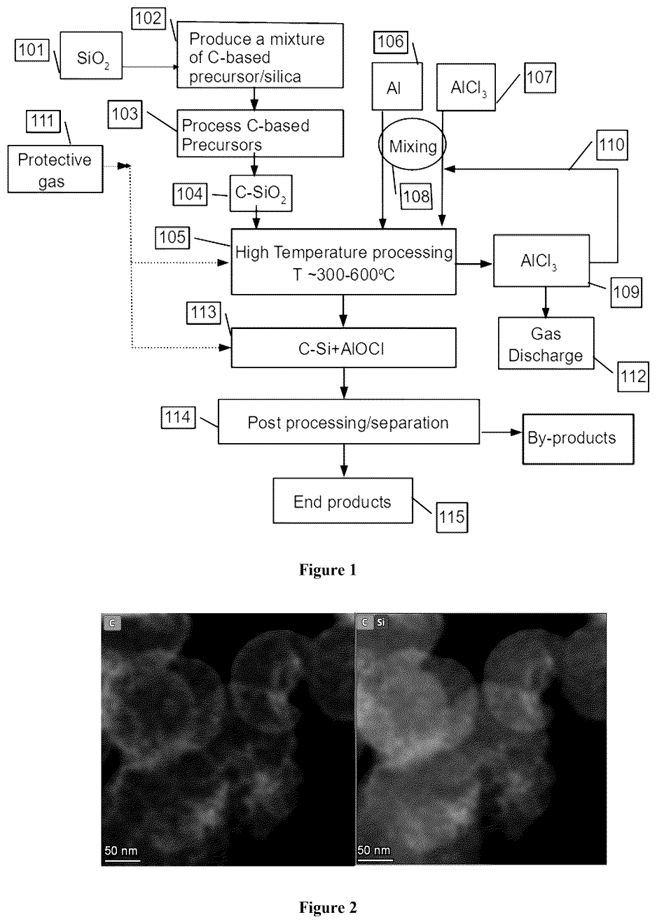

FIG. 1 is a schematic diagram illustrating processing steps for one preferred embodiment for reducing SiO₂ precursors with Al—AlCl₃. For this embodiment, an SiO₂-based precursor powder (101) is mixed with a C-based compound (102). The resulting powder is carbonized/pyrolyzed as needed depending on precursor (103) to produce a C—SiO₂-based powder (104); C—SiO₂. The C—SiO₂ precursor powders (104) is then fed into a reactor vessel (105) either in one batch or in a gradual way. Al powder (106) and AlCl₃ powder (107), are pre-mixed (108) and then gradually fed into the reactor vessel (105) equipped with a mixer (not shown) and set at a processing temperature Ti higher than threshold reaction temperature required for reducing the SiO₂. Alloying additives (not shown) may be fed separately or with other precursors depending on reactivity and compatibility at level (105) or elsewhere such as (101), (102), (103), (104) or (108).

Reactants in (105) are continuously mixed or reacted under still conditions for a certain residence time t₁, leading to formation of a solid product comprising metallic Si-based compounds and solid AlOCl by-products. Solid AlCl₃ fed into the reactor vessel in a solid form (as a part of the mixture Al—AlCl₃) sublimes to form gaseous AlCl₃, and a part of which reacts with the Al and SiO₂ in the reactor to form AlOCl. Another part of the gaseous AlCl₃ escapes or diffuses out of (105) and is condensed and collected in a dedicated vessel (109). A part or all the aluminium chlorides may be recycled through (110). All processing steps are preferably carried out under an inert gas (e.g., Ar) or a non-fully reactive gas (e.g., CO₂, N₂ . . . ) (111). At the exit of the by-product collection step, the gas is cleaned in a scrubber (112) before discharging into the atmosphere or recycling.

Solid reaction products including Si powder and AlOCl by-products, together with any other solid residuals if applicable (e.g., Al₂O₃, additive precursors . . . ) are discharged through (113). The reaction products (113) are then optionally post processed as needed (114) to separate metallic products from undesired residuals precursors (e.g., Al and unreacted SiO₂) and by-products leading to an end-product (115). Waste from the separation step (114) is processed and stored separately (116).

The reaction vessel (105) may be holding reactor vessel equipped with a mixer and operated in a batch mode, a semi-batch mode or in a continuous mode. Examples of a suitable vessels include conical reactors, auger-based reactor, rotary kiln, fluidized beds and packed bed reactors.

In one embodiment, a mixture of SiO₂ based precursor and Al are fed into a reaction vessel (105) at temperatures up to 650° C. in an atmosphere comprising gaseous AlCl₃ to induce reduction reactions leading to formation of powder products based on one or more of the base metals.

The SiO2 based precursors may first be loaded in a part or in full into the reaction vessel and heated to the reaction temperature. Then, the other reactants are fed into the reaction vessel as per any of the foregone or forthcoming embodiments.

The amount of AlCl₃ provided to react with the SiO₂—Al mixture can be regulated to suit the processing requirements and control reaction rate and reaction kinetics. In some embodiments, the aluminium chloride is passed as a gas stream over the SiO₂-based precursor/Al mixture, as a pure AlCl₃ gas or as a carrier gas/AlCl₃ mixture (e.g., N₂/AlCl₃.or Ar/AlCl₃). In one embodiment, the aluminium chloride is passed through the metal oxides/Al mixture as per configurations in fluidised bed systems.

In another embodiment for production of carbon-silicon-based composite materials, there is provided a method for producing powders based on Si, wherein:
the composition of the SiO2-based precursor can be any of: a multi-components powder comprising SiO₂, a pure SiO₂, precipitated silica powder, an SiO₂ nanopowder, fumed silica, silica fume, amorphous silica, quartz powder, glass powder, glass flakes, borosilicate glass powder or flakes, mica, synthetic mica or any other composition based on SiO₂; alternatively, the SiO₂-based precursor can be in the form of a soluble silicon-based compound that is impregnated into a graphite powder and then converted to SiO₂; and
Step 1: the particle size of the precursor silica-based powder is between a few nanometres and several hundred microns in at least one dimension; and
using the said SiO₂-based precursor powder to prepare a intermediate powder comprising carbon-precursor and SiO2-based precursor. The resulting intermediate powder may be carbonised or pyrolyzed to produce a C—SiO₂ powder; and
the said C—SiO₂-powder is reacted with Al and AlCl₃ (solid and or gaseous) to produce a powder product; and
the by-product is AlOCl, and the product is a mixture of silicon-based powder and solid AlOCl and residual Al; and
the products from Step 1 can be in the form of carbon-silicon composites; the silicon can be in the form of any one or a mixture of silicon powder, silicon nanopowder with a particle size less than 1 micron, pure silicon materials, a powder based on silicon monoxide SiO or SiOₓ where x is between 0.2 and 1.8, silicon-based powder with an oxygen content between 0.01 and 50 wt %, and the carbon silicon composite can be in the form of silicon-coated particulates, full Si—C composites, Si-impregnated graphite, natural graphite-Si, carbon-silicon composites derived from biomass, or any other form comprising carbon and silicon; and
Step 2: processing products from Step 1 to remove AlOCl by-products and/or residual Al to produce an end-product based on Si.

In one preferred embodiment, AlCl₃ is fed into the reaction vessel as a solid powder AlCl₃(s) and gaseous AlCl₃(g). Solid AlCl₃(s) powder is fed into the reaction vessel together with the other reactants and gaseous AlCl₃(g) can be fed into the vessel anywhere but preferably from the bottom and directed upwards through the reactants as for example per a conical reactor vessel, fluidised bed or packed bed arrangement. The solid AlCl₃(s) helps cool the reactant as it sublimes and some of it exists the reaction vessel while gaseous AlCl₃(g) is primarily intended to maximise reaction rate within the reactants.

In one embodiment for production of silicon-carbon materials, there is provided a method for producing powders based on Si, wherein:
there is provided a mixture of silica and a carbon-based precursor suitable for reacting with acids; examples of the carbon-based precursor include sucrose and examples of the acids include sulfuric acid,
reacting the mixture of silica and a carbon-based precursor to produce a silica-carbon mixture,
optionally pyrolyzing the silica-C mixture further to react any residual carbon-based precursor,
reacting the resulting silica-C mixture according to any of the foregone or forthcoming embodiments to produce a Si—C based material.

In one embodiment for production of silicon-carbon materials, there is provided a method for producing powders based on Si, wherein:
there is provided a liquid precursor comprising silicon suitable for production of silica; examples include silicic acid, sodium silicate and silicon alkoxides,
mixing the graphite powder with the liquid precursor and then reacting and/or calcining the liquid precursor to produce a mixture of graphite-SiO2,
reacting the mixture of silica and a carbon-based precursor to produce a silica-C mixture,
optionally pyrolyzing the silica-C mixture further to react any residual carbon-based precursor,
reacting the resulting silica-C mixture according to any of the foregone or forthcoming embodiments to produce a Si—C based material.

In one embodiment for production of carbon materials impregnated with silicon, there is provided a method for producing powders based on Si, wherein:
there is provided a liquid precursor comprising silicon suitable for production of silica; examples include silicic acid, sodium silicate and silicon alkoxides,
impregnating the carbon-based materials with the liquid precursor and then reacting and/or calcining the liquid precursor to produce a graphite-SiO₂ powder,
reacting the resulting mixture of carbon-based materials-silica according to any of the foregone or forthcoming embodiments to produce a Si—C based material.
The carbon-based materials can be graphite, synthetic graphite, natural graphite, activated carbon, charcoal, graphitic or carbonised materials produced from pyrolysis of organic materials such as pyrolyzed rice husks, graphitic materials produced by reacting organic materials with acids, or anode grade graphite powder. Forms of the graphitic materials, they can be in the form of flakes, or spherical powders and they can be coated or uncoated.

In one form of this embodiment, the liquid precursor is prepared by dissolving silica in NaOH solution to produce a sodium silicate solution. In another form, the liquid precursor is prepared from sodium silicate. In either forms, the method can include the steps of:
mixing or impregnating the carbon-based materials with silicate; and
reacting the liquid precursors with an acid (e.g., HCl) to produce convert the silicate to Si(OH)₄ or SiO₂; and
removing the by-products resulting from the last reacting step; and
reacting the resulting carbon-based materials and silicon-oxygen mixture with Al-aluminium chloride to any of the foregoing or following embodiments.

In one embodiment, the precursor materials consist of carbon-based materials-silica mixture consisting of natural graphite-silica minerals and then the precursor materials are reacted with Al-aluminium chloride to any of the foregoing or following embodiments.

In one embodiment, the precursor materials consist of carbon-based materials-silica mixture consisting of charcoal-silica and then the precursor materials are reacted with Al-aluminium chloride to any of the foregoing or following embodiments. In one form of this embodiment, the charcoal is first impregnated with silica coating precursors that is then converted to silica, and then the resulting materials is reacted with Al—AlCl₃ according to any of the foregoing or forthcoming embodiments.

In one embodiment for producing carbon-silicon composites, the method comprises:
providing a first powder of natural graphite containing silica at levels between 0.1% and 20% per weight; and
mixing, heating and reacting the said first powder with a reducing agent comprising aluminium and aluminium chloride to reduce at least a part of the silica to silicon and produce a carbon-silicon powder together with a byproduct of Al₂O₃ or AlOCl; and
optionally separating the carbon-silicon composites from the byproducts.

In one embodiment for producing carbon-silicon composites, wherein the natural graphite powder containing other impurities and the method include the step of reacting the impurities with a reducing agent based on aluminium-aluminium chloride and then dissolving the resulting impurity-based species and separate from the carbon-silicon product.

In one embodiment, the precursor materials consist of carbon-based materials-silica mixture consisting of charcoal-silica and then the precursor materials are reacted with Al-aluminium chloride to any of the foregoing or following embodiments. In one form of this embodiment, the charcoal is first impregnated with silica coating precursors that is then converted to silica, and then the resulting materials is reacted with Al—AlCl₃ according to any of the foregoing or forthcoming embodiments.

In one embodiment for producing carbon-silicon composites, the method comprises:
preparing a liquid solution containing dissolved silica precursors; and
providing a graphitic powder of charcoal and activated carbon materials; and
mixing the said solution with the graphitic powder; and
converting the silica precursor to silica; and
reacting the resulting carbon-silica materials with Al—AlCl₃ to produce C—Si composites; and
separating the carbon-silicon composites from the byproducts.

In one form of this embodiment, the method comprises:
preparing a liquid solution of sodium silicate and water; and
providing a charcoal powder; and
mixing the sodium silicate solution with the charcoal powder; and
adding diluted HCl in appropriate amounts to convert the sodium silicate to silicon hydroxide; and
reacting the resulting carbon-silica materials with Al—AlCl₃ to produce C—Si composites; and
filter the solid particulate powder; and
heating the solid particulate powder to convert the silica hydroxide to silica; and
reacting the resulting carbon-silica materials with Al—AlCl₃ to produce C—Si composites; and
separating the carbon-silicon composites from the byproducts.

In one form of this embodiment the heating is carried out at temperatures below 650° C.

In all embodiments, processing is carried out at pressures below 1.2 atmosphere.

In one embodiment wherein a carbon-coated silica powder is provided, the method can include the primary step of dissolving and/or etching a part of the silica to produce pores around the silica particulates and therefore produce Si—NP encased within carbon cages with enough voids within the cage to allow for volume increases of the Si—Np during lithiation.

In embodiments for partial reduction of precursors based on SiO₂ and producing Si coated substrates, SiO₂-based precursors are reacted with a sub-stoichiometric amount of Al in the presence of gaseous AlCl₃. The product is then in the form of an SiO₂-based substrate coated with Si. The SiO₂ precursors can be in the form of particulates such as powder, flakes or fibres. Metallic coating on the particulate surface may be continuous or patchy and may cover the whole or a part of the particulate surface. When the particulates are in the form of flakes, the coating can be reflective and then the particulates can be used in applications such as pigments. In other embodiments, the coated particulates can be further reacted with other precursor chemicals wherein metallic Si plays the role of a reducing agent.

In some embodiments, metal-based additives may be included in the reaction mixture to affect the properties of the end products. For example, additives based on one or more of Li, B, Na, Mg, Al, S, K, Ca, Ti, V, Cr, Mn, Fe, Co, Ni, Cu, Zn, Ge, Se, Zr, Nb, Mo, Ru, Rh, Pg, Ag, Sn, Sb, Hf, ta, W, Re, Os, Pt, Au and Bi may be included in the reaction mixture to include metallic impurities in the resulting C—Si products. In some other embodiments, the metal-based additive is adapted as a catalyst to induce formation of carbon-silicon composites in the form of carbon-silicon nanowires.

For example, AgCl additives may be included with the precursor chemicals, and the end-product is an SiO₂-substrate coated with Si—Ag or Ag, depending on the amount of Al and AgCl used and the required characteristics of the end-product.

The precursor may also include glass powder or glass flakes, fumed silica, silica fume, silica nanopowders, glass bubbles, and the product includes metallic silicon or metal silicides. In one form of this embodiment, the precursor oxides are in the form of flakes and the product is a powder with flake like morphology. In another form, the precursor powder includes fibres, and the product is a powder with fibre like morphology.

Solid reactants including the SiO₂ and the reducing Al alloy may, for example, be continuously mixed to maximise contact between the solid reactants and improve reaction yield.

In one embodiment, wherein the by-product is AlOCl, the AlOCl is separated from the metallic powder product by washing in a solvent suitable for dissolving AlOCl, and then separating the solid powder product.

Mixing and stirring of the reactants can help increase contact between the various components of the mixture and optimise product and maximise reaction yield. Stirring helps bring reducible precursor chemicals and unsaturated species produced during processing into contact with the reducing agent and then those species can react or disproportionate, and hence help improve the quality of the product. In a preferred embodiment, process conditions are arranged to maximise reactions between SiO₂ and Al—AlCl₃ through efficient mixing of the reactants.

The pressure in the reaction vessel must be below 1.5 atm, and preferably below 1.2 atm and more preferably the vessel is kept under a protective gas at a pressure around 1 atm and in open communication with external environment at 1 atm.

The precursor chemicals can be arranged in two or more materials streams that are fed together or independently into the reaction vessel and reacted to produce a powder product. In one variation of this form, the reactants can be processed at multiple temperatures for various processing times to optimise processing conditions and produce materials with desired characteristics.

In one embodiment, for example, the reactants may be introduced through several materials streams, including a stream comprising a mixture of the reducing alloy and the aluminium chloride. In one form of this embodiment, this mixture is produced through co-milling.

The process may be carried out in an inert gas, or in a non-reactive gas or in a mixture of non-reactive gas and a reactive gas; examples of adequate gases include Ar, N₂ or CO₂. In one embodiment, the gas stream consists of a mixture of Ar and reactive components such as NH₃.

In one embodiment, the method comprises an additional step wherein products obtained at the end of the process are reacted with further gaseous reactants at temperatures between 25° C. and 850° C. Gaseous reactants include gases containing reactive elements such as oxygen, nitrogen, boron and carbon. For example, the products may be heated in a stream of CH₄ to produce a Si—C based compounds.

In one embodiment, there is provided a carbon shell-silicon core products consisting of:
a porous carbon cage with a wall thickness between 0.01 nm and 1 micron; and
a cavity comprising silicon-based materials with at least 50% metallic silicon and empty space; and
the volume ratio of the empty space to Si is between 10% and 75% (e.g. between 10% and 50%).
the starting silica powder has an average diameter between 20 nm and 20 microns.

Example of this core-shell structure can be produced by any of the foregoing or forthcoming embodiments. For example, for producing the core-shell structure starting from 20 nm silica precursor powder and PVP precursor for carbon, the following steps are performed:
The silica powder has an average diameter 20 nm. The nominal density of the silica is 2.62 g/ml. The PVP composition is (C₆H₉NO)ₙ with 65 wt % nominal carbon content.
The silica powder is coated with PVP. PVP amount used corresponds to between 0.1 wt % and 100 wt % relative to the silica weight. The PVP coated silica is then pyrolysed, leading to a carbon coating between 0.065 wt % and 65 wt % relative to the silica.
The carbon-coated silica is then reduced at 450 C with Al—AlCl₃, wherein the silica is reduced to silicon. The ratio of the carbon to silicon is between 0.1 wt % and to 130 wt %.
When the silica is fully reduced to silicon, its volume reduces by 49% leading to formation of a shell with a core consisting of 50% Si and 50% void.

The invention extends to materials made using the method in all its embodiments and forms, without being limited by the examples provided herein by way of illustration. Materials produced by preferred forms of the invention described here may have unique characteristics that may not be obtained using prior art methods. Specific example properties may include the ability to produce nanostructured products with large area and compositions usually unachievable with conventional techniques.

One example of materials with unique characteristics obtained using current technology is silicon nanoparticles with metallic additives for use in Li-ion batteries. Such materials are characterised by large surface area and superior conductivity resulting from addition of base metal additives.

Silicon nanoparticles produced according to the present invention include crystalline silicon and amorphous silicon, including products containing various ratios of crystalline and amorphous phases.

Silicon nanoparticles produced according to the present method have irregular particular shape with a particle size range from 10 nm to 500 nm and include Al at levels 0.01 wt % and 70 wt %. Other variants of this product include silicon nanoparticles with Ag, Cu and/or tin at levels between 0.1 wt % and 50 wt %.

The following are examples of preparation of various product compounds in accordance with an embodiment of the present invention.

### Example 1: C—Si Nanocrystals Starting from Fumed Silica

Fumed silica (SiO₂) was reacted with Al under Ar—AlCl₃ at 1 atm at a temperature of 550° C. Al and AlCl₃ were premixed together. The SiO₂ and the Al—AlCl₃ were fed as two separate streams into the reactor over a period of 15 min. The temperature of the reactants was continuously monitored and only moderate temperature increases were detected. Materials obtained at the end of the test have a deep brown colour with a yield >97%; some materials are lost during processing and handling. An XRD analysis of the as-produced materials shows they consist of AlOCl and Si and carbon; only lines corresponding to crystalline silicon can be observed and measured patterns XRD suggest the materials are free of Al₂O₃. Also, broad shallow features corresponding to C seem to indicate presence of carbon.

TEM analysis of as produced powder suggests a particle size distribution between 20 nm and 100 nm. SEM analysis confirms the presence of agglomerates with a broad particle size distribution between 50 nm and 200 nm and that has been observed to result from the washing process. If pure H₂O is used with no HCl, the Si particulates remain suspended in the water indefinitely, and particle size distribution is in the range 10-100 nm.

### Example 2: C—Si Nanocrystals Starting from C—SiO₂ Nanopowder

100 g of SiO₂ nanopowder (70 nm) are mixed with 100 ml distilled water and 1 g sugar. The mixture is stirred continuously for 10 minutes to make sure it is all homogenous, and then heated until all water is evaporated. The resulting sugar-SiO2 powder is then pyrolyzed at 525° C. under nitrogen.

The resulting C—SiO₂ is reacted with Al and AlCl₃ under argon at 1 atm at less than 525° C. Excess AlCl₃ is collected in a dedicated vessel for later use. The materials were gradually fed into the reactor as two separate streams over 30 minutes; one SiO₂ stream and one Al—AlCl₃ mixture stream.

Materials have a brown colour—amount collected is 290 g. Materials discharged and washed in diluted HCl. XRD patterns of washed products match the known XRD spectra of crystalline silicon, and the materials are substantially free of Al₂O₃.

### Example 3: C—Si Starting from Quartz Powder

51 g C-quartz powder (0.5-10 microns) was processed with 32 g Al under argon-AlCl₃ at 1 atm at a temperature of 550° C. Excess AlCl₃ is collected in a dedicated vessel for later use.

Materials discharged and washed in diluted HCl. XRD patterns of the product show the quartz powder has only partially been reduced. All lines in the patterns can be indexed to the known XRD spectra of quartz and silicon.

### Example 4: C—Si Starting from SiO₂ Fume

A mixture of C—SiO₂ derived from silica fume with around 5% carbon was processed under argon-AlCl₃ at 1 atm at 525° C. the C coating is produced in a way similar to Example 1.

Analysis of the products show Si and C as expected.

### Example 5: SiO₂ Coated with C—Si

82 g SiO₂ nanopowder (20 nm) are mixed with 100 ml distilled water and 1 g sucrose. The mixture is stirred continuously for 10 minutes to make sure it is all homogenous, and then heated until all water is evaporated. The resulting sucrose-coated powder is then pyrolyzed under nitrogen.

The resulting C—SiO₂ nanopowders are processed with Al powder (4 microns) under argon-AlCl₃ at 1 atm at a maximum temperature of 500° C. The SiO₂ were partially reduced, and the products consisted of SiO₂—Si—C. Amount of collected materials is ˜167 g.

Materials discharged and washed in diluted HCl. XRD patterns of the product show crystalline silicon and a broad peak around 22 degrees corresponding to amorphous silica.

### Example 6: Glass Flakes Coated with C-Silicon

200 g of borosilicate glass flakes (−60 microns diameter and 1 micron thick) were mixed with 100 ml of distilled water and 1 g sucrose. The mixture was stirred continuously for 10 minutes to make sure it is all homogenous, and then heated until all water is evaporated. The resulting sugar-coated powder was then pyrolyzed under nitrogen.

The resulting powder was processed with Al—AlCl₃ (12.5 g Al) under Ar at 550° C. Products are then discharged and washed in H₂O.

Materials have a golden colour and consist of borosilicate flakes coated with Si. The XRD analysis shows shallow Si peaks.

### Example 7: C—Si Starting from C—SiO₂ Nanopowder

25 g of SiO₂ nanopowder (70 nm) coated with 2% with polyvinylpyrrolidone (PVP) is first pyrolyzed under argon at 500° C. leading to a SiO₂—C composition. The SiO₂—C is mixed with 6 g of a mixture of Al powder (4 microns) and 30 g of AlCl₃(s).

The resulting C—SiO₂—Al—AlCl₃ is reacted under argon at 1 atm at 550° C. Excess AlCl₃ is collected in a dedicated vessel for later use. The materials were gradually fed into the reactor as two separate streams over 10 minutes.

Materials have a light grey-brown colour-amount collected is 72 g. Materials discharged and washed in diluted HCl. XRD patterns of washed products match the known XRD spectra of silicon. TEM of the powder shows the C—Si product to be in the form of Si aggregates with carbon coating as a rough surface around the individual particulates. Also, the analysis suggest the Si nanoparticles are mostly nanocrystalline but contains a fraction of amorphous phase. TEM-EDS micrograph of the powder showing C and C—Si morphology is presented in FIG. 2.

### Example 8: C—Si Starting from C—SiO₂ Nanopowder

Step 1: nanopowder (20 nm) are mixed with distilled water and PVP. The mixture is stirred to make sure it is all homogenous, and then heated until all water is evaporated. The resulting PVP-coated powder is then pyrolyzed at 550° C. under argon.
Step 2: Step 1 is repeated three times.
Step 3: The SiO₂—C is mixed with Al powder (4 microns) and AlCl₃(s). The resulting C—SiO₂—Al—AlCl₃ is reacted under argon at 1 atm at 550° C. Excess AlCl₃ is collected in a dedicated vessel for later use. The materials were gradually fed into the reactor as two separate streams over 10 minutes.

Materials discharged and washed in diluted HCl. XRD patterns of washed products match the known XRD spectra of silicon. TEM of the powder shows a complex structure where Si aggregates and particulates are caged within porous carbon coating.

### Example 9: C—Si Starting from C—SiO₂ Nanopowder

SiO₂ nanopowder (20 nm) are mixed with distilled water and PVP. The mixture is then heated until all water is evaporated. The resulting PVP-coated powder is then pyrolyzed at 550° C. under argon.

The SiO₂—C is mixed with Al powder and AlCl₃(s), and the resulting C—SiO₂—Al—AlCl₃ is reacted under argon at 1 atm. Excess AlCl₃ is collected in a dedicated vessel for later use. The materials were gradually fed into the reactor as two separate streams.

Materials discharged and washed in diluted HCl. XRD patterns of washed products match the known XRD spectra of silicon. TEM of the powder shows Si aggregates and particulates are caged within porous carbon coating.

### Example 10: C—Si Nanoparticles Starting from C—SiO₂ Nanoparticles

Step 1: An amount of PVP is dissolved in water. Then, SiO₂ powder is added and mixed thoroughly.
Step 2: the water is evaporated and the remaining solid PVP coated silica is pyrolyzed under argon at 500° C. leading to a SiO₂—C composition.
Step 3: the SiO₂—C is mixed with Al powder and AlCl₃(s).

The resulting C—SiO₂—Al—AlCl₃ is reacted under argon at 550° C. Excess AlCl₃ is collected in a dedicated vessel for later use. The materials were gradually fed into the reactor as two separate streams over 10 minutes.

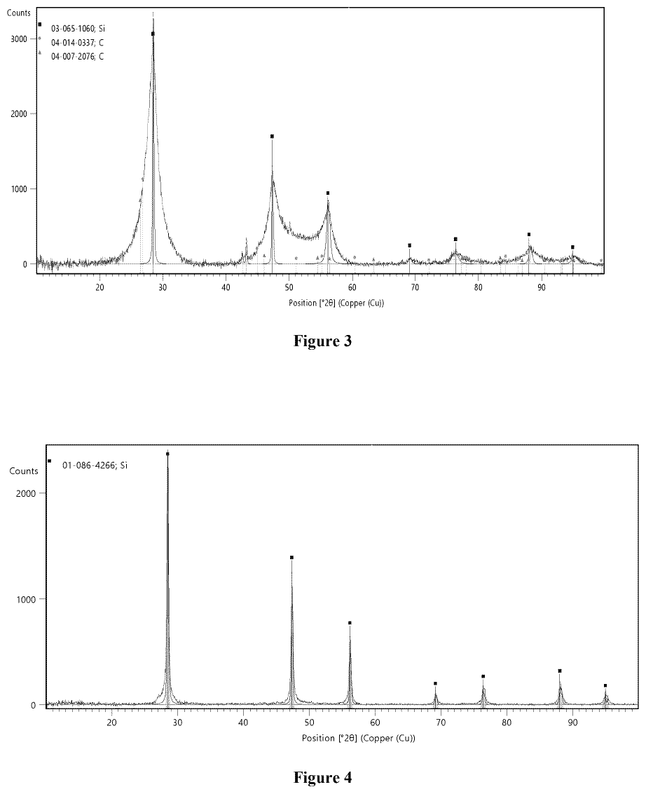

Materials have a light grey-brown colour. Materials discharged and washed in diluted HCl. XRD patterns of washed products match the known XRD spectra of silicon but with very wide peaks. XRD is shown in FIG. 3. Calculations of particle sizes based FWHM suggest a particle size less than 7 nm. For reference, in FIG. 4, we present XRD trace for a pure Si sample obtained without the carbon coating. The small particle size obtained is due to the carbon coating preventing agglomeration and sintering of the individual Si nanoparticles. TEM of the powder shows the C—Si product to be in the form of Si aggregates with carbon coating as a rough surface around the individual particulates. The TEM analysis suggests the presence of a significant amorphous fraction.

### Example 11: C—Si Nanoparticles Starting from C—SiO₂ Nanoparticles

Step 1: PVP is dissolved in water. Then, SiO₂ nanopowder (70 nm) is added and mixed thoroughly.
Step 2: the water is evaporated and the remaining solid PVP coated silica is pyrolyzed leading to a SiO₂—C composition.
Step 3: the SiO₂—C is mixed with Al powder and AlCl₃(s).

The resulting C—SiO₂—Al—AlCl₃ is reacted under argon. Excess AlCl₃ is collected in a dedicated vessel for later use. The materials were gradually fed into the reactor as two separate streams over 10 minutes.

Materials have a light grey-brown colour. Materials discharged and washed in diluted HCl. XRD patterns of washed products match the known XRD spectra of silicon but with very wide peaks. TEM of the powder shows the C—Si product to be in the form of Si aggregates with carbon coating as a rough surface around the individual particulates. The TEM analysis suggest the presence of a amorphous fraction.

### Example 12: C—Si Starting from C—SiO₂ Precipitated Silica

SiO₂ powder (precipitated silica) coated with 2% with polyvinylpyrrolidone (PVP) is first pyrolyzed leading to a SiO₂—C composition. The SiO₂—C is mixed Al powder and AlCl₃(s).

The resulting C—SiO₂—Al—AlCl₃ is reacted under argon at 1 atm at 475° C. Excess AlCl₃ is collected in a dedicated vessel for later use.

Materials have a light grey-brown colour. Materials discharged and washed. XRD patterns of washed products match the known XRD spectra of silicon. TEM of the powder shows the C—Si product to be in the form of Si aggregates with carbon coating as a rough surface around the individual particulates.

### Example 13: C—Si Starting from C—SiO₂ Halloysites

SiO₂ of powder (halloysites) are coated with 1% with polyvinylpyrrolidone (PVP) is first pyrolyzed under argon at 550° C. leading to a SiO₂—C composition. The SiO₂—C is mixed with Al powder and AlCl₃(s).

The resulting C—SiO₂—Al—AlCl₃ is reacted under argon at 550° C. Excess AlCl₃ is collected in a dedicated vessel for later use.

Materials discharged and washed. XRD patterns of washed products match the known XRD spectra of silicon and Al₂O₃. The Al₂O₃ is most likely due to presence of the oxide in the halloysite composition.

### Example 14: C—Si Starting from C—SiO₂ Halloysites

SiO₂ powder (halloysites) are washed with sulphuric acid to de-aluminate the materials and increase the SiO2 concentration in the powder. The powder is then coated with 2% with polyvinylpyrrolidone (PVP) and pyrolyzed under argon at 525° C. leading to a SiO₂—C composition. The SiO₂—C is mixed with 6 g of Al powder and AlCl₃(s).

The resulting C—SiO₂—Al—AlCl₃ is reacted under argon at 1 atm at 525° C. Excess AlCl₃ is collected in a dedicated vessel for later use.

Materials discharged and washed. XRD patterns of washed products match the known XRD spectra of silicon.

### Example 15: Si Impregnated Graphite Powder

Sodium silicate powder is dissolved in water. A porous graphite powder is added to the solution. HCl is then added to the solution. The mixture is then heated at 300 degrees. The dried mixture is washed multiple times in water to remove undesired NaCl. The resulting graphite-SiO₂ powder is then reacted with Al—AlCl3. The products are washed to remove the AlOCl by-products. The resulting materials consist of graphite impregnated with Si—NP.

### Example 16: Si Impregnated Graphite Powder

Sodium silicate are dissolved in water. Porous graphite powder is added to the solution and stirred for 2 hours. HCl is then added to the solution. The mixture is then calcined at 300 degrees. The dried mixture is washed to remove the NaCl byproducts.

A diluted solution of sodium hydroxide is added and the mixture is heated and stirred at to dissolve a part of the SiO2 and create void around the silica particulates. The materials are filtered and washed and then dried.

The resulting Graphite-SiO2 powder is then reacted with Al—AlCl3. The products are washed to remove the AlOCl by-products. The resulting materials consist of graphite impregnated with Si—NP.

### Example 17: Si Impregnated Graphite Powder Produced from Sucrose

Precipitated silica and sucrose are dissolved in water and stirred until fully homogenised. Then the solution is heated until water is fully evaporated.

H2SO4 is added to the materials and sucrose is converted to porous carbon. The precipitated silica particles are encased within the pores of the resulting carbined materials.

Materials are then reacted with Al—AlCl3 as described before and the end products are in the form of Si-impregnated porous graphite powder.

### Example 18: Si Impregnated Graphite Powder Produced from Sucrose

Precipitated silica and sucrose are dissolved in in water and stirred until fully homogenised. Then the solution is heated until water is fully evaporated.

H2SO4 is added to the materials and Sucrose is converted to porous carbon. The precipitated silica particles are encased with the resulting graphitic pores.

A diluted solution of sodium hydroxide is added and the mixture is heated to dissolve a part of the SiO2 and create void around the silica particulates. The materials are filtered and washed and then dried.

The resulting materials are then reacted with Al—AlCl3 as described before and the end products are in the form of Si-impregnated porous graphite powder.

### Example 19: Graphite-Si Composite from Natural Graphite

A natural graphite powder with a nominal composition containing 7% silica, 2% magnesium oxide and 3.2% aluminium oxide, is mixed with an Al powder and AlCl3. The mixture is then processed at 550° C. The powder is washed with diluted HCl and then filtered and dried. XRD analysis of the powder shows the silica has been reduced to silicon with all lines corresponding to silicon present in the XRD patterns. No evidence of Mg compounds in seen in the final products suggesting the MgO has been converted to MgCl2 and removed during the washing step.

### Example 20: Graphite-Si Composite Using Charcoal

Sodium silicate are dissolved in water. A charcoal powder is then added and stirred with the solution of 2 hours. Diluted HCl is added to the solution. The mixture is then filtered and dried and the resulting powder is heated at 500° C. leading to formation of charcoal-silica mixture.

### Example 21: C—Si Composites Starting from Graphite and Precipitated Silica

Precipitated silica are mixed with 300 g of graphite powder (C—SiO2 powder) and loaded into a reactor and heated to 550° C.

A mixture of Al—AlCl₃ is gradually fed onto the reaction vessel containing the C—SiO2 powder. Excess AlCl₃ is collected in a dedicated vessel for later use. Amount of collected materials is 605 g. Materials discharged and washed in diluted HCl.

### Example 22: C—Si Composites Starting from Rice Husks

A powder of dry pyrolyzed rice husks is loaded into a reactor and heated to 550° C.

Al powder is mixed with AlCl₃ and the mixture is gradually fed onto the reaction vessel containing the C—SiO2 powder. Materials discharged and washed in excess diluted HCl to remove the AlOCl and residual Al powder. XRD materials shows patterns consistent with Si and C phases with no other compounds.

The resulting mixture is processed at temperatures between 475° C. and 550° C. The products are discharged and washed with diluted HCl and then filtered and dried. XRD analysis of the powder shows the silica has been reduced to silicon.

It will be understood to persons skilled in the art of the invention that many modifications may be made without departing from the spirit and scope of the invention. For example, the inventors expect that it would be possible to use Mg instead of Al as the reducing agent without significant departures from the core of the invention. If Mg is used instead of Al, for example, by-products might include a mixture of MgAl₂Cl₈ and AlOCl, both of which are soluble in diluted HCl and should thus be separable from the base metal products. It is intended that such modifications are within the scope of the present invention.

It is to be understood that any prior art publication referred to herein does not constitute an admission that the publication forms part of the common general knowledge in the art.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for producing carbon-silicon composites, the method comprising:
providing a reaction mixture comprising a carbon-silica-based precursor and an aluminium reductant;
heating the reaction mixture in the presence of solid or gaseous aluminium chloride, or a mixture thereof, to a temperature at which reactions that result in the silica being reduced are initiated;
controlling reaction conditions whereby the reaction mixture is prevented from reaching a temperature at which thermal runaway can occur; and
isolating the produced carbon-silicon composites.

2. The method of claim 1, wherein the carbon-silica-based precursor is provided in the form of one or more of: a carbon-silica composite, a mixture of carbon powder and a silica-based powder, a carbon-coated silica powder, carbon cages encasing silica-based precursor particulates, carbon nanotubes or thin graphitic sheets or graphene blended with silica particulates or coated onto the particulates, a reducible carbon-silicon-oxygen based powder, a porous carbon-based structure impregnated with silica, a silica-impregnated carbon-based powder, a silica-impregnated graphite powder, a silica-impregnated charcoal powder, pyrolyzed rice husks, a powder of natural graphite that contains silica, or a mixture thereof.

3. The method of claim 1 or claim 2, wherein the carbon-silica-based precursor is provided in the form of a powder, flakes, fibres or particulates.

4. The method of any one of claims 1 to 3, further comprising pyrolyzing a mixture of a silica-containing substance and a carbon-based compound to produce the carbon-silica-based precursor.

5. The method of claim 4, wherein carbon-based compound is selected from the group consisting of one or more of the following: an organic compound, a polymer, a carbohydrate, a saccharide, glucose, sucrose, biomass and a hydrocarbon.

6. The method of claim 4 or claim 5, wherein the carbon-based compound is applied to the silica-containing substance by physical deposition, chemical deposition or wet processing.

7. The method of any one of claims 1 to 3, further comprising impregnating a carbon-based material with a liquid precursor comprising silicon and then treating the resulting material to produce a carbon-silica-based precursor in the form of a graphite-silica powder.

8. The method of claim 7, wherein the liquid precursor comprising silicon is selected from one or more of: silicic acid, sodium silicate and silicon alkoxides.

9. The method of claim 7 or claim 8, wherein the carbon-based material is selected from one or more of: graphite, synthetic graphite, natural graphite, activated carbon, graphene, carbon nanotubes, graphite-minerals mixture, charcoal powder, pyrolyzed rice husks, carbonised materials produced from pyrolysis of organic materials, graphitic or carbonised materials produced by reacting organic materials with acids, and anode grade graphite powder.

10. The method of any one of claims 1 to 9, wherein the silica in the carbon-silica-based precursor is provided in the form of a powder, independent particulates, particulates impregned within the carbon structure, or in the form of other morphologies comprising silica.

11. The method of any one of claims 1 to 10, wherein the silica in the carbon-silica-based precursor is provided as one or more of: silica nanopowder, fumed silica, precipitated silica, silica fume, silica fibre, silicate, borosilicate, soda glass, silica-based minerals, synthetic mica, mica and crystalline silica.

12. The method of any one of claims 1 to 11, wherein the silica in the carbon-silica-based precursor have a particle size of less than 100 microns, preferably less than 10 microns, more preferably less than 5 microns, and still more preferably less than 500 nm.

13. The method of any one of claims 1 to 12, wherein the solid aluminium chloride is provided in the form of a powder or granules of aluminium chloride with a particle size less than 5 mm.

14. The method of any one of claims 1 to 13, wherein the aluminium chloride is included in the reaction mixture.

15. The method of any one of claims 1 to 14, where the gaseous aluminium chloride is caused to flow over or through the reaction mixture during heating.

16. The method of any one of claims 1 to 15, wherein the amount of the aluminium chloride provided is between 1 wt % and 500 wt % of the weight of the carbon-silica-based precursor.

17. The method of any one of claims 1 to 16, wherein the aluminium reductant is aluminium or an aluminium alloy.

18. The method of any one of claims 1 to 17, wherein the aluminium reductant is provided in the form of a powder or flakes with a particle size of less than about 50 μm in at least one dimension.

19. The method of any one of claims 1 to 18, wherein the amount of the aluminium reductant in the reaction mixture is between 1% and 1000% of the weight of the silica in the carbon-silica-based precursor, and preferably between 5 wt % and 500 wt % of the weight of the silica in the carbon-silica-based precursor.

20. The method of any one of claims 1 to 19, wherein the temperature to which the reaction mixture is heated is less than 800° C., preferably less than 600° C. or preferably less than 550° C.

21. The method of any one of claims 1 to 20, wherein the reaction mixture is heated in a non-reactive atmosphere and preferably in an inert atmosphere.

22. The method of any one of claims 1 to 21, wherein the reaction mixture is heated at a pressure of between about 0.8 to 1.2 atmospheres, preferably at atmospheric pressure.

23. The method of any one of claims 1 to 22, wherein the reaction conditions are controlled by one or more of the following: gradually feeding additional one or both of the carbon-silica-based precursor and the aluminium reductant into the reaction mixture as it is heated; by externally cooling the reaction mixture; by cooling the reaction mixture with excess amounts of solid aluminium chloride; and by adding a thermal load moderator to the reaction mixture.

24. The method of any one of claims 1 to 23, wherein a metal-based catalyst is included in the reaction mixture.

25. The method of any one of claims 1 to 24, wherein additives based on one or more of Li, B, Na, Mg, Al, S, K, Ca, Ti, V, Cr, Mn, Fe, Co, Ni, Cu, Zn, Ge, Se, Zr, Nb, Mo, Ru, Rh, Pg, Ag, Sn, Sb, Hf, Ta, W, Re, Os, Pt, Au and Bi are included in the reaction mixture.

26. The method of claim 24 or claim 25, wherein the metal-based catalyst or additive is adapted to induce formation of carbon-silicon composites in the form of carbon-silicon nanowires.

27. The method of any one of claims 1 to 23, wherein the carbon-silicon composites comprise silicon nanoparticles encased within carbon-based structures.

28. The method of claim 27, further comprising processing the carbon-silica-based precursor to control the volume of empty space within the carbon-based structures.

29. The method of claim 27 or claim 28, wherein the carbon-based structures are carbon-based shells.

30. The method of claim 29, wherein the core comprises empty space of between 0.5% and 75% of the total volume of the core.

31. The method of any one of claims 1 to 30, wherein the carbon-silicon composites comprise between 0.01 wt % and 70 wt % residual aluminium.

32. The method of any one of claims 1 to 31, wherein the carbon-silicon composites include silicon-compounds having an average composition corresponding to SiOx, where x is between 0 and 1.9.

33. A carbon-coated silicon nanoparticle produced according to the method of claim 1, wherein the silicon nanoparticles are in the form of particulates having irregular shapes and a mean particle size of between 10 nm and 500 nm and include between 0.01 wt % and 70 wt % aluminium.

34. A carbon-silicon composite produced according to the method of claim 1, wherein the composite comprises particles having a silicon-containing core and a coating having a thickness of between 1 nm and 300 nm and containing at least 50 wt % silicon.

35. A carbon-silicon composite produced according to the method of claim 1, wherein the composite is in the form of a core-shell structure, wherein:
the core comprises empty space of between 0.5% and 75% of the total volume of the core and silicon-based materials with a metallic silicon content less than 99 wt %; and
the shell comprises a porous or non-porous carbon coating having a thickness between 0.01 nm and 1 micron.

36. A method for reducing silica in a silica-based precursor, the method comprising:
coating a silica-based powder with carbon to produce a carbon-coated silica-based precursor;
providing a reaction mixture comprising the carbon-coated silica-based precursor and an aluminium reductant;
heating the reaction mixture in the presence of solid or gaseous aluminium chloride, or a mixture thereof, to a temperature at which reactions that result in the silica being reduced are initiated;
controlling reaction conditions whereby the reaction mixture is prevented from reaching a temperature at which thermal runaway can occur; and
isolating reaction products that include reduced silica.

37. The method of claim 1, the method comprising:
mixing a liquid soluble carbon-based compound with a solvent and a silica-based precursor; and
evaporating the solvent to produce a silica-based precursor coated with a carbon-based compound;
pyrolyzing the silica-based precursor coated with a carbon-based compound to produce a carbon-coated silica-based precursor;
heating a reaction mixture comprising the carbon-coated silica-based precursor and an aluminium reductant at substantially atmospheric pressure and in the presence of gaseous aluminium chloride to a temperature at which reactions that result in the SiO₂ being reduced are initiated;
controlling reaction conditions whereby the reaction mixture is prevented from exceeding a temperature of about 650° C.; and
isolating reaction products that include silicon.

38. The method of claim 1 for producing carbon-silicon composites in the form of carbon-silicon nanowires, the method comprising:
forming a reaction mixture of carbon, a silica-based powder, an aluminium reductant and a metal catalyst, wherein the weight of the catalyst is between 5% and 50% of the weight of the silica, and wherein the catalyst induces formation of silicon nanowires;
heating the reaction mixture at atmospheric pressure in the presence of gaseous aluminium chloride to a temperature at which reactions that result in the SiO₂ being reduced are initiated;
controlling reaction conditions whereby the reaction mixture is prevented from exceeding a temperature of about 650° C.; and
isolating reaction products that include carbon-silicon nanowires.

39. The method of claim 38, further comprising:
impregnating a carbon-based material with a liquid precursor comprising silicon and then treating the resultant material to produce the silica-based powder in the form of a graphite-silica-based powder.

40. A method for producing carbon-silicon composites, the method comprising:
providing a powder of natural graphite which contains between 0.1% and 20% per weight silica; and
mixing and heating the powder with a reducing agent comprising aluminium in the presence of solid and/or gaseous aluminium chloride, whereby at least a part of the silica is reduced to silicon and a carbon-silicon composite powder is produced, together with a byproduct comprising Al₂O₃ and/or AlOCl; and
optionally separating the carbon-silicon composites from the byproducts.

41. Carbon-silicon composites produced according to the method of any one of claims 1 to 32 and 36 to 40.

42. Silicon-impregnated carbon-based composites produced according to the method of any one of claims 1 to 32 and 36 to 40, wherein the carbon-based material in the carbon-silica-based precursor is graphite, pyrolyzed biomaterials or activated carbon.

43. A natural graphite-silicon composite produced according to the method of claim 1 or claim 40, wherein silica impurities in natural graphite are converted in part or in full to silicon to produce a compound of natural graphite-Si composite, wherein the silicon content is between 0.5 wt % and 25 wt %.

44. A carbon-silicon composite produced according to the method of any one of claims 1 to 32 and 36 to 40, wherein silica in pyrolyzed carbon-silica precursor compounds is reduced to silicon; the silicon content is between 1 wt % and 25 wt %.

45. A carbon-silicon composite consisting of carbon, silicon and aluminium.

46. A carbon-silicon composite produced solely from rise husks.

47. The carbon-silicon composite of claim 45 or claim 46, produced according to claim 1.
